(19) United States
(12) Patent Application Publication
(10) Pub. No.: US 2021/0410176 A1
(43) Pub. Date: Dec. 30, 2021

(54) MINIMUM SCHEDULING GAP FOR INTEGRATED ACCESS AND BACKHAUL NETWORK

(71) Applicant: QUALCOMM Incorporated, San Diego, CA (US)

(72) Inventors: Jianghong LUO, Skillman, NJ (US); Navid ABEDINI, Somerset, NJ (US); Tao LUO, San Diego, CA (US); Luca BLESSENT, Whitehouse Station, NJ (US); Karl Georg HAMPEL, Hoboken, NJ (US); Junyi LI, Chester, NJ (US)

(21) Appl. No.: 16/914,069

(22) Filed: Jun. 26, 2020

(51) Int. Cl. H04W 72/14; H04W 88/14; H04W 72/12; H04W 80/02; H04L 27/26; H04L 5/00; H04L 1/16; H04W 76/27

(52) U.S. Cl. CPC H04W 72/14; H04W 88/14; H04W 72/1263; H04W 76/27; H04L 27/2607; H04L 5/0051; H04L 1/1614; H04W 80/02

(57) ABSTRACT

Various aspects of the present disclosure generally relate to wireless communication. In some aspects, a first node may transmit a grant for a communication associated with a scheduling gap, wherein the scheduling gap is imposed with a minimum value over a set of resources, and communicate with a second node based at least in part on the grant. Numerous other aspects are provided.

### FIELD OF THE DISCLOSURE

Aspects of the present disclosure generally relate to wireless communication and specifically, to techniques and apparatuses for a minimum scheduling gap for an integrated access and backhaul (IAB) network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, or transmit power, among other examples, or a combination thereof). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, and even global level. New Radio (NR), which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM or SC-FDMA (for example, also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements are applicable to other multiple access technologies and the telecommunication standards that employ these technologies.

Some wireless communication systems may include a wireless backhaul network, sometimes referred to as an integrated access and backhaul (IAB) network. In an IAB network, at least one base station is an anchor base station, also referred to as an IAB donor. The IAB network also includes one or more non-anchor base stations, sometimes referred to as relay base stations or TAB nodes. An anchor base station may communicate with a core network via a wired backhaul link. A non-anchor base station may communicate directly or indirectly (for example, via one or more other non-anchor base stations) with the anchor base station via one or more wireless backhaul links to form a backhaul path to the core network for carrying backhaul traffic. Additionally, each of the anchor base stations and non-anchor base stations may communicate with one or more UEs via wireless access links carrying access traffic.

In an IAB network, the scheduling of one IAB node may be dependent on another TAB node's scheduling. For example, in some scenarios, a child node's scheduling may be dependent on a parent node's scheduling, or a parent node's scheduling may be dependent on another parent node's scheduling (in a multi-IAB network). The use of minimum values of scheduling gaps may assist in the scheduling of TAB traffic without violating these dependencies. However, the indiscriminate or uniform application of minimum values of scheduling gaps introduces latency and overhead to the IAB network.

### SUMMARY

In some aspects, a method of wireless communication, performed by a first node in an TAB network, may include transmitting a grant for a communication associated with a scheduling gap, wherein the scheduling gap is imposed with a threshold value over a set of resources. The method may include communicating with a second node based at least in part on the grant.

In some aspects, a method of wireless communication, performed by a first node in an IAB network, may include receiving information indicating a scheduling gap associated with a second node, wherein the scheduling gap is imposed with a threshold value over a set of resources. The method may include communicating based at least in part on the scheduling gap.

In some aspects, a first node in an IAB network for wireless communication may include a memory and one or more processors operatively coupled to the memory. The memory and the one or more processors may be configured to transmit a grant for a communication associated with a scheduling gap, wherein the scheduling gap is imposed with a threshold value over a set of resources. The memory and the one or more processors may be configured to communicate with a second node based at least in part on the grant.

In some aspects, a first node in an IAB network for wireless communication may include a memory and one or more processors operatively coupled to the memory. The memory and the one or more processors may be configured to receive information indicating a scheduling gap associated with a second node, wherein the scheduling gap is imposed with a threshold value over a set of resources. The memory and the one or more processors may be configured to communicate based at least in part on the scheduling gap.

In some aspects, a non-transitory computer-readable medium may store one or more instructions for wireless communication. The one or more instructions, when executed by one or more processors of a first node in an IAB network, may cause the one or more processors to transmit a grant for a communication associated with a scheduling gap, wherein the scheduling gap is imposed with a threshold value over a set of resources. The one or more instructions, when executed by one or more processors of a first node, may cause the one or more processors to communicate with a second node based at least in part on the grant.

In some aspects, a non-transitory computer-readable medium may store one or more instructions for wireless communication. The one or more instructions, when executed by one or more processors of a first node in an IAB network, may cause the one or more processors to receive information indicating a scheduling gap associated with a second node, wherein the scheduling gap is imposed with a threshold value over a set of resources. The one or more instructions, when executed by one or more processors of a first node, may cause the one or more processors to communicate based at least in part on the scheduling gap.

In some aspects, an apparatus for wireless communication may include means for transmitting a grant for a communication associated with a scheduling gap, wherein the scheduling gap is imposed with a threshold value over a set of resources. The apparatus may include means for communicating with a node based at least in part on the grant.

In some aspects, an apparatus for wireless communication may include means for receiving information indicating a scheduling gap associated with a node, wherein the scheduling gap is imposed with a threshold value over a set of resources. The apparatus may include means for communicating based at least in part on the scheduling gap.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with various aspects of the present disclosure.

FIG. 2 is a diagram illustrating an example base station (BS) in communication with a user equipment (UE) in a wireless network in accordance with various aspects of the present disclosure.

FIG. 3 is a diagram illustrating examples of radio access networks in accordance with various aspects of the disclosure.

FIG. 4 is a diagram illustrating an example of an integrated access and backhaul (TAB) network architecture in accordance with various aspects of the disclosure.

FIG. 5 is a diagram illustrating an example of resource types in an TAB network in accordance with various aspects of the disclosure.

FIG. 6 is a diagram illustrating an example of communication capabilities for TAB nodes in accordance with various aspects of the present disclosure.

FIGS. 7, 8, 9, and 10 are diagrams illustrating examples of implicit determination of availability of soft resources and conditional use of resources at an TAB node with an enhanced duplex capability in accordance with various aspects of the present disclosure.

FIG. 11 is a diagram illustrating an example of imposing a minimum value on a set of resources associated with a scheduling gap in accordance with various aspects of the present disclosure.

FIG. 12 is a diagram illustrating an example of determination and imposition of a minimum value for a scheduling gap in accordance with various aspects of the present disclosure.

FIG. 13 shows an example of signaling and determination of a minimum value for a scheduling gap by a CU in accordance with various aspects of the present disclosure.

FIGS. 14 and 15 are diagrams illustrating examples of imposition of a minimum value for a scheduling gap on a set of resources in a multi-parent TAB network in accordance with various aspects of the present disclosure.

FIGS. 16 and 17 are flowcharts illustrating example processes for configuring a minimum scheduling gap for an TAB network performed, for example, by a node in an TAB network, in accordance with various aspects of the present disclosure.

FIGS. 18 and 19 are block diagrams of example apparatuses for wireless communication in accordance with various aspects of the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms, among other examples, or combinations thereof (collectively referred to as “elements”). These elements may be implemented using hardware, software, or combinations thereof. Whether such elements are implemented as hardware or software depends upon the particular application and design constraints imposed on the overall system.

Various aspects relate generally to scheduling in an IAB network. Some aspects more specifically relate to imposing minimum values on scheduling gaps in connection with scheduling in an IAB network. In some aspects, the minimum values are applied to sets of resources or subsets of resources of a communication link of an IAB node. For example, a minimum value can be directly associated with a set of resources. As another example, a minimum value can be imposed on a set of resources based at least in part on a scenario (also referred to as a situation) associated with the set of resources, as described in more detail elsewhere herein. For example, a minimum value for a scheduling gap can be imposed based at least in part on a scenario, such as implicit determination of availability of soft resources, scheduling of overlapped resources by a full duplex capability IAB node, or a transition between a mobile termination function and a distributed unit function.

Particular aspects of the subject matter described in this disclosure can be implemented to realize one or more of the following potential advantages. In some examples, the described techniques can be used to improve efficiency of scheduling upstream and downstream IAB communications. Furthermore, the described techniques can be used to improve latency and overhead relative to schemes that indiscriminately apply minimum values for scheduling gaps, and relative to indiscriminately applying scheduling gaps for all resources.

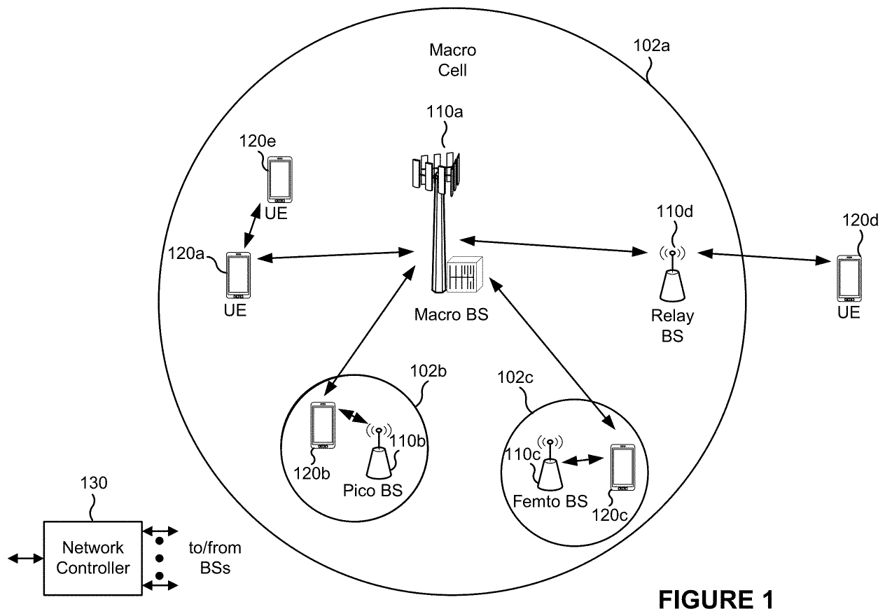

FIG. 1 is a diagram illustrating an example of a wireless network in accordance with various aspects of the present disclosure. The wireless network may be or may include elements of a 5G (NR) network or an LTE network, among other examples. The wireless network may include one or more base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, or a transmit receive point (TRP), among other examples. Each BS may provide communication coverage for a particular geographic area. In 3GPP, the term “cell” can refer to a coverage area of a BS or a BS subsystem serving this coverage area, depending on the context in which the term is used.

A BS may provide communication coverage for a macro cell, a pico cell, a femto cell, or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). ABS for a macro cell may be referred to as a macro BS. A BS for a pico cell may be referred to as a pico BS. A BS for a femto cell may be referred to as a femto BS or a home BS. ABS may support one or multiple (for example, three) cells.

The wireless network may be a heterogeneous network that includes BSs of different types, for example, macro BSs, pico BSs, femto BSs, or relay BSs, among other examples, or combinations thereof. These different types of BSs may have different transmit power levels, different coverage areas, and different impacts on interference in the wireless network. For example, macro BSs may have a high transmit power level (for example, 5 to 40 watts) whereas pico BSs, femto BSs, and relay BSs may have lower transmit power levels (for example, 0.1 to 2 watts). In the example shown in FIG. 1, a BS 110a may be a macro BS for a macro cell 102a, a BS 110b may be a pico BS for a pico cell 102b, and a BS 110c may be a femto BS for a femto cell 102c. A network controller 130 may couple to the set of BSs 102a, 102b, 110a and 110b, and may provide coordination and control for these BSs. Network controller 130 may communicate with the BSs via a backhaul. The BSs may also communicate with one another, for example, directly or indirectly via a wireless or wireline backhaul.

In some aspects, a cell may not be stationary, rather, the geographic area of the cell may move in accordance with the location of a mobile BS. In some aspects, the BSs may be interconnected to one another or to one or more other BSs or network nodes (not shown) in the wireless network through various types of backhaul interfaces such as a direct physical connection, or a virtual network, among other examples, or combinations thereof using any suitable transport network.

The wireless network may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, or a relay, among other examples, or combinations thereof.

UEs 120 (for example, 120a, 120b, 120c) may be dispersed throughout the wireless network, and each UE may be stationary or mobile. A UE may also be referred to as an access terminal, a terminal, a mobile station, a subscriber unit, or a station, among other examples, or combinations thereof. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless medium.

Some UEs may be considered machine-type communication (MTC) or evolved or enhanced machine-type communication (eMTC) UEs. MTC and eMTC UEs include, for example, robots, drones, remote devices, sensors, meters, monitors or location tags, among other examples, or combinations thereof, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, or may be implemented as NB-IoT (narrowband interne of things) devices. Some UEs may be considered a Customer Premises Equipment (CPE). UE 120 may be included inside a housing that houses components of UE 120, such as processor components, or memory components, among other examples, or combinations thereof.

In general, any quantity of wireless networks may be deployed in a given geographic area. Each wireless network may support a particular radio access technology (RAT) and may operate on one or more frequencies or frequency channels. A frequency may also be referred to as a carrier among other examples. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly with one another using one or more sidelink channels (for example, without using a base station 110 as an intermediary). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, or a vehicle-to-infrastructure (V2I) protocol, among other examples, or combinations thereof), or a mesh network, among other examples, or combinations thereof. In such examples, the UE 120 may perform scheduling operations, resource selection operations, or other operations described elsewhere herein as being performed by the base station 110.

Devices of the wireless network may communicate using the electromagnetic spectrum, which may be subdivided based on frequency or wavelength into various classes, bands, or channels. For example, devices of the wireless network may communicate using an operating band having a first frequency range (FR1), which may span from 410 MHz to 7.125 GHz. As another example, devices of the wireless network may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” may broadly represent frequencies less than 6 GHz, frequencies within FR1, mid-band frequencies (for example, greater than 7.125 GHz), or a combination thereof. Similarly, unless specifically stated otherwise, it should be understood that the term “millimeter wave” may broadly represent frequencies within the EHF band, frequencies within FR2, mid-band frequencies (for example, less than 24.25 GHz), or a combination thereof. The frequencies included in FR1 and FR2 may be modified, and techniques described herein are applicable to those modified frequency ranges.

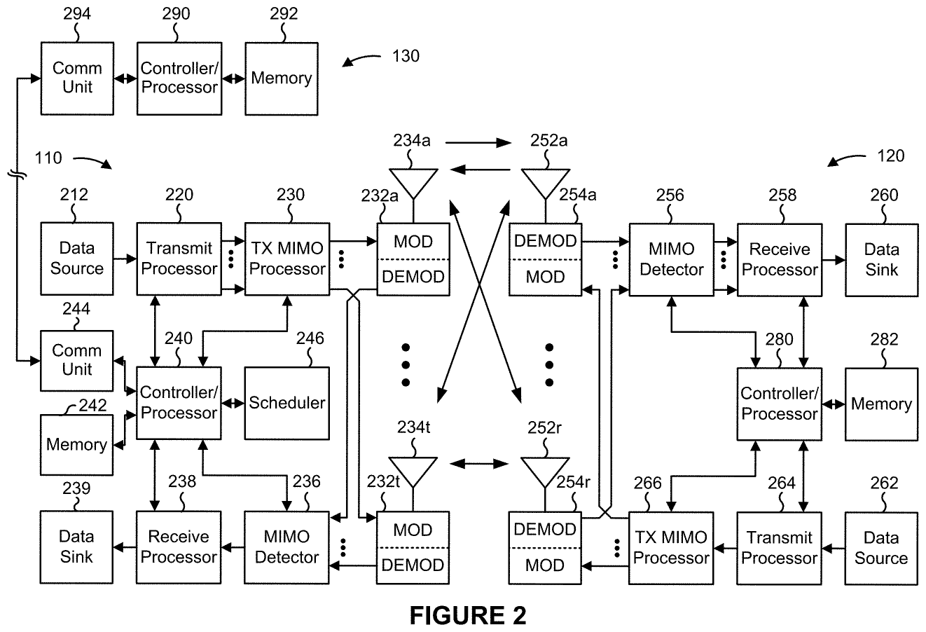

FIG. 2 is a diagram illustrating an example base station in communication with a UE in a wireless network in accordance with various aspects of the present disclosure. The base station may correspond to base station 110 of FIG. 1. Similarly, the UE may correspond to UE 120 of FIG. 1.

Base station 110 may be equipped with T antennas 234a through 234t, and UE 120 may be equipped with R antennas 252a through 252r, where in general T≥1 and R≥1. At base station 110, a transmit processor 220 may receive data from a data source 212 for one or more UEs, select one or more modulation and coding schemes (MCSs) for each UE based at least in part on channel quality indicators (CQIs) received from the UE, process (for example, encode) the data for each UE based at least in part on the MCS(s) selected for the UE, and provide data symbols for all UEs. Transmit processor 220 may also process system information (for example, for semi-static resource partitioning information (SRPI) among other examples) and control information (for example, CQI requests, grants, or upper layer signaling, among other examples, or combinations thereof) and provide overhead symbols and control symbols. Transmit processor 220 may also generate reference symbols for reference signals and synchronization signals. A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each MOD 232 may process a respective output symbol stream (for example, for OFDM among other examples) to obtain an output sample stream. Each MOD 232 may further process (for example, convert to analog, amplify, filter, and upconvert) the output sample stream to obtain a downlink signal. T downlink signals from MODs 232a through 232t may be transmitted via T antennas 234a through 234t, respectively.

At UE 120, antennas 252a through 252r may receive the downlink signals from base station 110 or other base stations and may provide received signals to R demodulators (DEMODs) 254a through 254r, respectively. Each DEMOD 254 may condition (for example, filter, amplify, downconvert, and digitize) a received signal to obtain input samples. Each DEMOD 254 may further process the input samples (for example, for OFDM) to obtain received symbols. A MIMO detector 256 may obtain received symbols from all R DEMODs 254a through 254r, perform MIMO detection on the received symbols if applicable, and provide detected symbols. A receive processor 258 may process (for example, decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP), a received signal strength indicator (RSSI), a reference signal received quality (RSRQ), or a channel quality indicator (CQI), among other examples, or combinations thereof In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 as well as control information (for example, for reports including RSRP, RSSI, RSRQ, or CQI, among other examples, or combinations thereof) from controller/processor 280. Transmit processor 264 may also generate reference symbols for one or more reference signals. The symbols from transmit processor 264 may be precoded by a TX MIMO processor 266 if applicable, further processed by MODs 254a through 254r (for example, for discrete Fourier transform spread orthogonal frequency division multiplexing (DFT-s-OFDM), or orthogonal frequency division multiplexing (OFDM) with a cyclic prefix (CP) (CP-OFDM), among other examples, or combinations thereof), and transmitted to base station 110. In some aspects, the UE 120 includes a transceiver. The transceiver may include any combination of antenna(s) 252, modulators 254, demodulators 254, MIMO detector 256, receive processor 258, transmit processor 264, or TX MIMO processor 266. The transceiver may be used by a processor (for example, controller/processor 280) and memory 282 to perform aspects of any of the methods described herein.

At base station 110, the uplink signals from UE 120 and other UEs may be received by antennas 234, processed by DEMODs 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and uplink communications. In some aspects, the base station 110 includes a transceiver. The transceiver may include any combination of antenna(s) 234, modulators 232, demodulators 232, MIMO detector 236, receive processor 238, transmit processor 220, or TX MIMO processor 230. The transceiver may be used by a processor (for example, controller/processor 240) and memory 242 to perform aspects of any of the methods described herein.

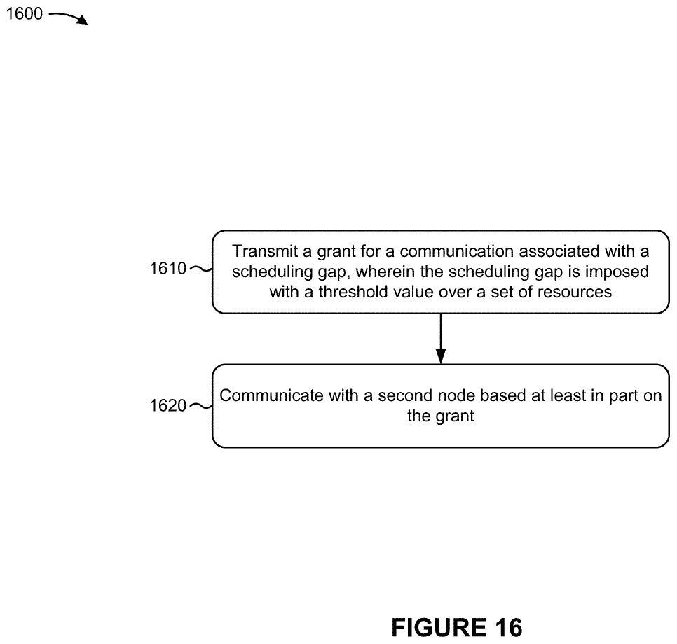

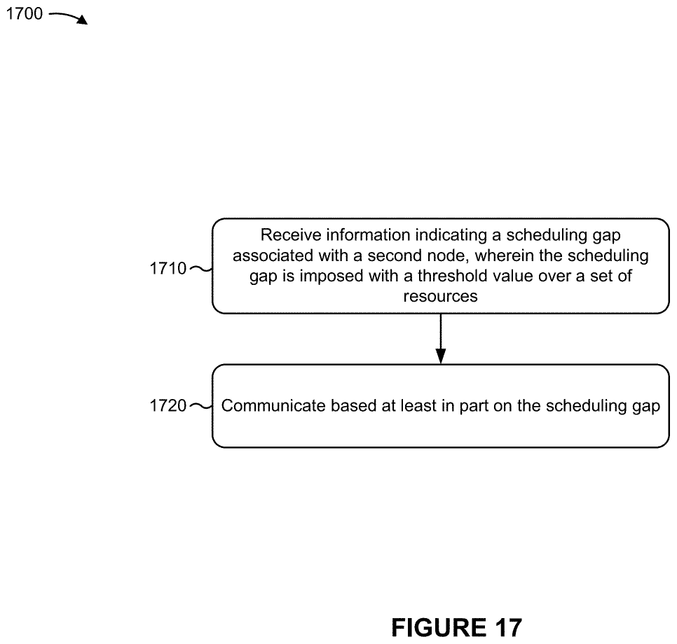

Controller/processor 240 of base station 110, controller/processor 280 of UE 120, or any other component(s) of FIG. 2 may perform one or more techniques associated with imposing a minimum value on a scheduling gap for a set of resources, as described in more detail elsewhere herein. For example, controller/processor 240 of base station 110, controller/processor 280 of UE 120, or any other component(s) of FIG. 2 may perform or direct operations of, for example, process 1600 of FIG. 16, process 1700 of FIG. 17, or other processes as described herein. Memories 242 and 282 may store data and program codes for base station 110 and UE 120, respectively. In some aspects, memory 242 or memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 1600 of FIG. 16, process 1700 of FIG. 17, or other processes as described herein. In some aspects, executing instructions may include running the instructions, converting the instructions, compiling the instructions, or interpreting the instructions, among other examples.

In some aspects, UE 120 may include at least means for transmitting a grant for a communication associated with a scheduling gap and means for communicating with a node based at least in part on the grant. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, or receive processor 258.

In some aspects, base station 110 may include at least means for receiving information indicating a scheduling gap associated with a second node and means for communicating based at least in part on the minimum value. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, or antenna 234, among other examples.

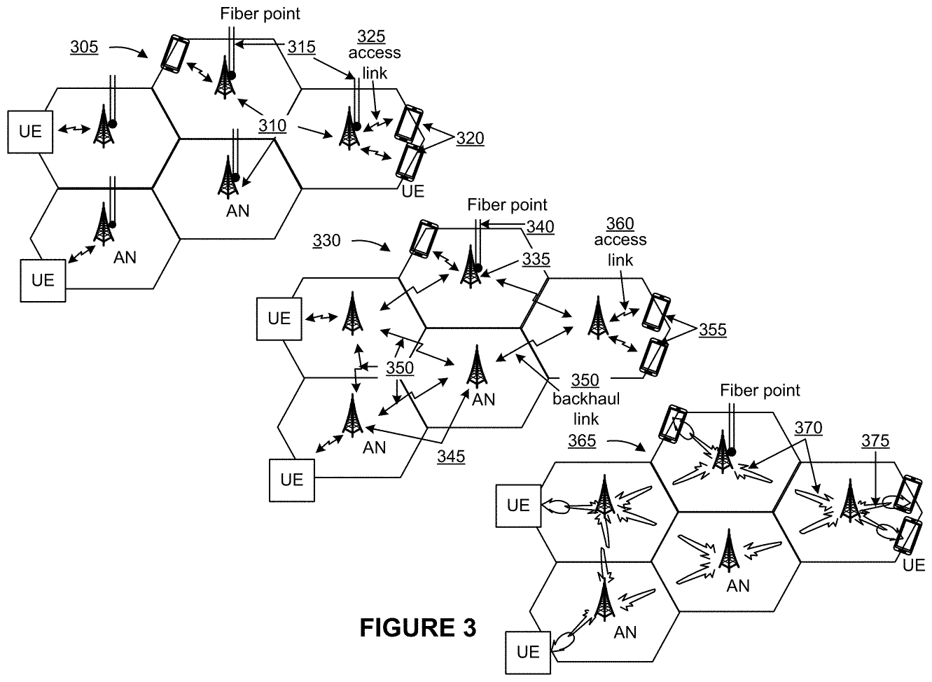

FIG. 3 is a diagram illustrating examples of radio access networks in accordance with various aspects of the disclosure. As shown by reference number 305, a traditional (for example, 3G, 4G, or LTE) radio access network may include multiple base stations 310 (for example, access nodes (AN)), where each base station 310 communicates with a core network via a wired backhaul link 315, such as a fiber connection. A base station 310 may communicate with a UE 320 via a wireless access link 325. In some aspects, a base station 310 shown in FIG. 3 may be a base station 110 shown in FIG. 1. In some aspects, a UE 320 shown in FIG. 3 may be a UE 120 shown in FIG. 1.

As shown by reference number 330, a radio access network may include a wireless backhaul network, sometimes referred to as an integrated access and backhaul (TAB) network. In an TAB network, at least one base station is an anchor base station 335 that communicates with a core network via a wired backhaul link 340, such as a fiber connection. An anchor base station 335 may also be referred to as an TAB donor (or IAB-donor). The TAB network may include one or more non-anchor base stations 345, sometimes referred to as relay base stations or TAB nodes (or IAB-nodes). The non-anchor base station 345 may communicate directly or indirectly with the anchor base station 335 via one or more backhaul links 350 (for example, via one or more non-anchor base stations 345) to form a backhaul path to the core network for carrying backhaul traffic. Backhaul link 350 may be a wireless link. Anchor base station(s) 335 or non-anchor base station(s) 345 may communicate with one or more UEs 355 via wireless access links 360 that carry access traffic. In some aspects, an anchor base station 335 or a non-anchor base station 345 shown in FIG. 3 may be a base station 110 shown in FIG. 1. In some aspects, a UE 355 shown in FIG. 3 may be a UE 120 shown in FIG. 1.

As shown by reference number 365, in some aspects, a radio access network that includes an TAB network may utilize millimeter wave technology or directional communications (for example, beamforming) for communications between base stations or UEs (for example, between two base stations, between two UEs, or between a base station and a UE). For example, wireless backhaul links 370 between base stations may use millimeter wave signals to carry information or may otherwise be directed toward a target base station using beamforming. Similarly, the wireless access links 375 between a UE and a base station may use millimeter wave signals or may otherwise be directed toward a target wireless node (for example, a UE or a base station). In this way, inter-link interference may be reduced.

The configuration of base stations and UEs in FIG. 3 is shown as an example, and other examples are contemplated. For example, one or more base stations illustrated in FIG. 3 may be replaced by one or more UEs that communicate via a UE-to-UE access network (for example, a peer-to-peer network or a device-to-device network). In this case, “anchor node” may refer to a UE that is directly in communication with a base station (for example, an anchor base station or a non-anchor base station). As indicated above, FIG. 3 is provided as an example. Other examples may differ from what is described with regard to FIG. 3.

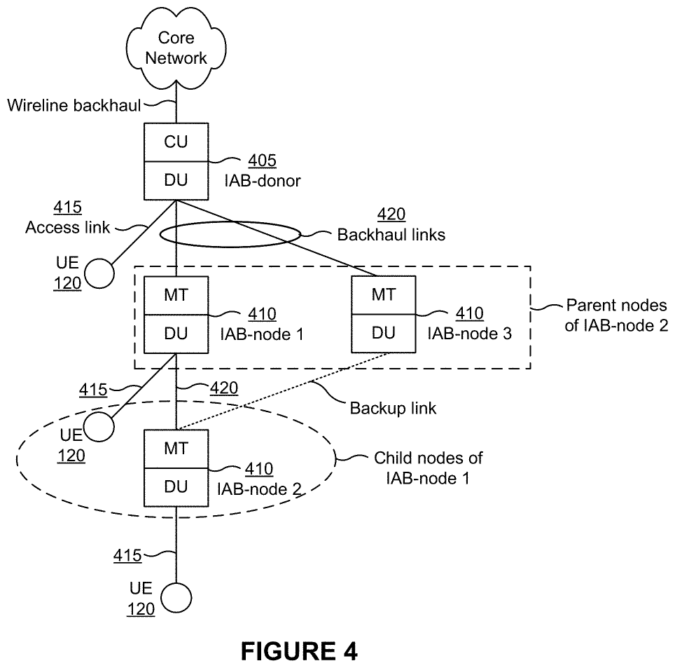

FIG. 4 is a diagram illustrating an example of an IAB network architecture in accordance with various aspects of the disclosure. As shown in FIG. 4, an IAB network may include an IAB donor 405 (shown as IAB-donor) that connects to a core network via a wired connection (shown as a wireline backhaul). For example, an Ng interface of an IAB donor 405 may terminate at a core network. Additionally or alternatively, an IAB donor 405 may connect to one or more devices of the core network that provide a core access and mobility management function (for example, AMF). In some aspects, an IAB donor 405 may include a base station 110, such as an anchor base station, as described above in connection with FIG. 3. As shown, an IAB donor 405 may include a central unit (CU), which may perform access node controller (ANC) functions or AMF functions. The CU may configure a distributed unit (DU) of the IAB donor 405 or may configure one or more IAB nodes 410 (for example, an MT or a DU of an IAB node 410) that connect to the core network via the IAB donor 405. Thus, a CU of an IAB donor 405 may control or configure the entire IAB network that connects to the core network via the IAB donor 405, such as by using control messages or configuration messages (for example, a radio resource control (RRC) configuration message or an F1 application protocol (FLAP) message).

As further shown in FIG. 4, the IAB network may include IAB nodes 410 (shown as IAB-node 1, IAB-node 2, and IAB-node 3) that connect to the core network via the IAB donor 405. As shown, an IAB node 410 may include mobile termination (MT) functions (also sometimes referred to as UE functions (UEF)) and may include DU functions (also sometimes referred to as access node functions (ANF)). The MT functions of an IAB node 410 (for example, a child node) may be controlled or scheduled by another IAB node 410 (for example, a parent node of the child node) or by an IAB donor 405. The DU functions of an IAB node 410 (for example, a parent node) may control or schedule other IAB nodes 410 (for example, child nodes of the parent node) or UEs 120. Thus, a DU may be referred to as a scheduling node or a scheduling component, and an MT may be referred to as a scheduled node or a scheduled component. In some aspects, an IAB donor 405 may include DU functions and not MT functions. That is, an IAB donor 405 may configure, control, or schedule communications of IAB nodes 410 or UEs 120 but is not configured, controlled or scheduled by a parent IAB node. A UE 120 may include only MT functions and not DU functions. That is, communications of a UE 120 may be controlled or scheduled by an IAB donor 405 or an IAB node 410 (for example, a parent node of the UE 120) but the UE may not configure, control or schedule any child nodes.

As used herein, “node” or “wireless node” may refer to an IAB donor 405 or an IAB node 410. As indicated above, when a first node controls or schedules communications for a second node (for example, when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control or schedule communications for child nodes of the parent node. A parent node may be an IAB donor 405 or an IAB node 410, and a child node may be an IAB node 410 or a UE 120. Communications of an MT function of a child node may be controlled or scheduled by a parent node of the child node.

As further shown in FIG. 4, a link between a UE 120 (for example, which only has MT functions but not DU functions) and an IAB donor 405, or between a UE 120 and an IAB node 410, may be referred to as an access link 415. Access link 415 may be a wireless access link that provides a UE 120 with radio access to a core network via an IAB donor 405, and in some deployments via one or more intervening or intermediary IAB nodes 410. Thus, the network illustrated in 4 may be referred to as a multi-hop network or a wireless multi-hop network.

As further shown in FIG. 4, a link between an IAB donor 405 and an IAB node 410 or between two IAB nodes 410 may be referred to as a backhaul link 420. Backhaul link 420 may be a wireless backhaul link that provides an IAB node 410 with radio access to a core network via an IAB donor 405, and in some deployments via one or more other intervening or intermediary IAB nodes 410. In an IAB network, network resources for wireless communications (for example, time resources, frequency resources, or spatial resources) may be shared between access links 415 and backhaul links 420. In some aspects, a backhaul link 420 may be a primary backhaul link or a secondary backhaul link (for example, a backup backhaul link). In some aspects, a secondary backhaul link may be used if a primary backhaul link fails or becomes congested or overloaded. For example, a backup link 425 between IAB-node 2 and IAB-node 3 may be used for backhaul communications if a primary backhaul link between IAB-node 2 and IAB-node 1 fails. As indicated above, FIG. 4 is provided as an example. Other examples may differ from what is described with regard to FIG. 4.

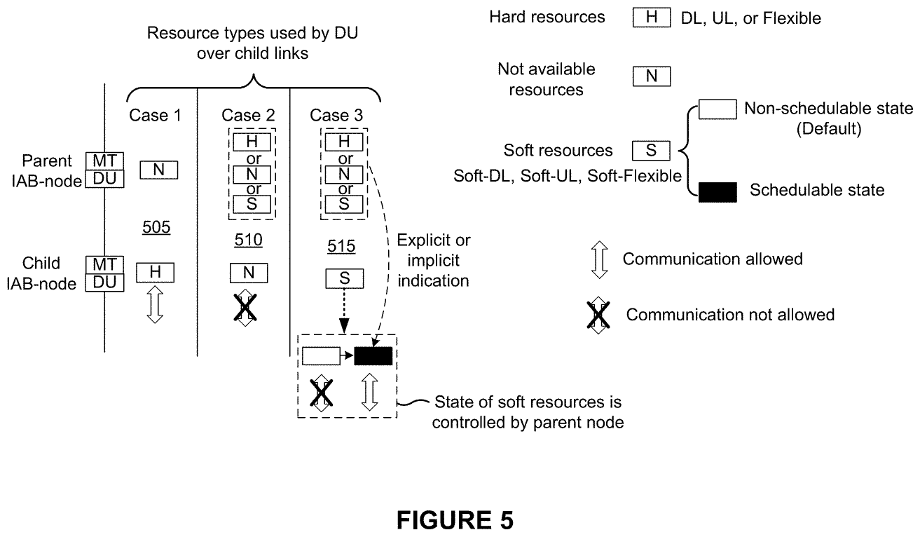

FIG. 5 is a diagram illustrating an example of resource types in an IAB network in accordance with various aspects of the disclosure. In an IAB network, time domain resources (also referred to simply as “time resources”) may be configured as downlink-only, uplink-only, flexible, or not available (for example, unavailable). When a time resource is configured as downlink-only for a wireless node, that time resource may be available for only downlink communications of the wireless node, and not uplink communications. Similarly, when a time resource is configured as uplink-only for a wireless node, that time resource may be available for only uplink communications of the wireless node, and not downlink communications. When a time resource is configured as flexible for a wireless node, that time resource may be available for both downlink communications and uplink communications of the wireless node. When a time resource is configured as not available for a wireless node, that time resource may not be used for any communications of the wireless node.

Examples of downlink communications include synchronization signal blocks (SSBs), channel state information reference signals (CSI-RS), physical downlink control channel (PDCCH) communications, and physical downlink shared channel (PDSCH) communications. Examples of uplink communications include physical random access channel (PRACH) communications, physical uplink control channel (PUCCH) communications, physical uplink shared channel (PUSCH) communications, and sounding reference signals (SRS).

Time resources in an IAB network that are configured as downlink-only, uplink-only, or flexible may be further configured as hard resources or soft resources. When a time resource is configured as a hard resource for a wireless node, that time resource is always available for communications of the wireless node. For example, a hard downlink-only time resource is always available for only downlink communications of the wireless node, a hard uplink-only time resource is always available for only uplink communications of the wireless node, and a hard flexible time resource is always available for uplink or downlink communications of the wireless node.

When a time resource is configured as a soft resource for a wireless node, the availability of that time resource is controlled by a parent node of the wireless node. For example, the parent node may indicate (for example, explicitly or implicitly) whether a soft time resource is available for communications of the wireless node. Thus, a soft time resource may be in one of two states: a schedulable state (for example, when the soft time resource is available for scheduling or communications of the wireless node) and a non-schedulable state (for example, when the soft time resource is not available for scheduling and is not available for communications of the wireless node). For example, a soft downlink-only time resource is only available for downlink communications of the wireless node when a parent node of the wireless node indicates that the soft downlink-only time resource is available. Similarly, a soft uplink-only time resource is only available for uplink communications of the wireless node when a parent node of the wireless node indicates that the soft uplink-only time resource is available. A soft flexible time resource is only available for uplink and downlink communications of the wireless node when a parent node of the wireless node indicates that the soft flexible time resource is available.

As an example, and as shown by reference number 505, a time resource may be configured as hard for a child node, and may be configured as not available for a parent node of the child node. In this case, the parent node cannot communicate using that time resource, but the child node can schedule communications in that time resource or communicate using that time resource. This configuration may reduce interference between the parent node and the child node and may reduce scheduling conflicts between the parent node and the child node.

As another example, and as shown by reference number 510, a time resource may be configured as not available for the child node, and may be configured as hard, soft, or not available for the parent node (for example, depending on a network configuration, network conditions, or a configuration of a parent node of the parent node). In this case, the child node cannot schedule communications in that time resource and cannot communicate using that time resource.

As another example, and as shown by reference number 515, a time resource may be configured as soft for the child node, and may be configured as hard, soft, or not available for the parent node (for example, depending on a network configuration, network conditions, or a configuration of a parent node of the parent node). In this case, the child node cannot schedule or communicate using the time resource unless the child node receives an indication (for example, a release indication), from the parent node (for example, explicitly or implicitly), that the time resource is available (i.e., released) for use by the child node. If the child node receives such an indication, then the child node can schedule communications in that time resource or communicate using that time resource.

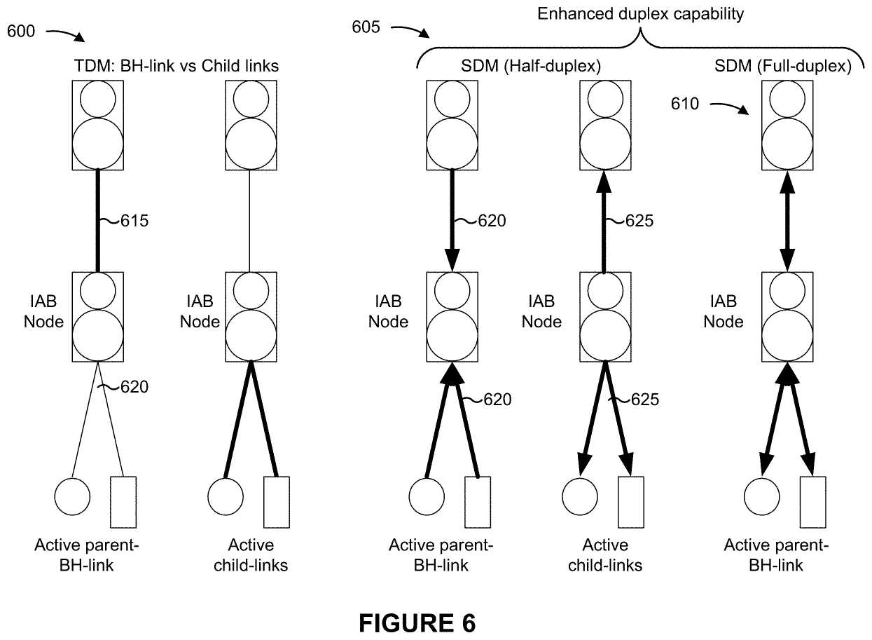

FIG. 6 is a diagram illustrating examples 600, 605 and 610 of communication capabilities for IAB nodes. In example 600, an IAB node is associated with a time division multiplexing (TDM) capability, and in examples 605 and 610, an IAB node is associated with an enhanced duplex capability. A TDM capability, as shown in example 600, may mean that the IAB node time division multiplexes communications on a parent link 610 with communications on child links 615. For example, an IAB node associated with a TDM capability may not be capable of simultaneously communicating on a parent link 610 and a child link 615. Active communication on a link of FIG. 6 is illustrated by a thicker line, such as on the parent link 615 in the left portion of example 600, and non-active communication on a link is illustrated by a thinner line. In contrast, an IAB node associated with an enhanced duplex capability is capable of simultaneously communicating on a parent link 610 and a child link 615. For example, example 605 shows an IAB node capable of simultaneously performing reception on a parent link 610 and a child link 615 (as indicated by the arrows 620 inbound to the IAB node on the parent link 610 and the child link 615), or simultaneously performing transmission on the parent link 610 and the child link 615 (as indicated by the arrows 625 outbound from the IAB node on the parent link 610 and the child link 615). The duplexing configuration shown in example 605 may be achieved by spatial division multiplexing (SDM) in a half-duplex fashion. As another example, example 610 shows an IAB node capable of full-duplex communication using SDM. For example, the IAB node may be capable of simultaneous transmission and reception on the parent link 610 and the child link 615. In some aspects, a full-duplex capable IAB node may be capable of performing simultaneous transmission to a first node and reception from a second node. In some aspects, a full-duplex capable IAB node may be capable of simultaneous transmission to a node and reception from the node. In some aspects, a full-duplex capable IAB node may be capable of simultaneous transmission to and reception from a first node and transmission to and reception from a second node. In some aspects, one or more of the enhanced duplex capabilities associated with examples 605 and 610 may be conditional (such as conditional on a beam direction) and dynamic.

A scheduling gap identifies a length of time between two channels, such as a slot offset between the two channels. For example, a K0 scheduling gap may identify a minimum number of slots between receiving a physical downlink control channel (PDCCH) downlink control information (DCI) scheduling a physical downlink shared channel (PDSCH), and receiving the PDSCH. A K0 scheduling gap of 0, for example, may mean that a DCI on a PDCCH can schedule a PDSCH in the same slot, whereas a K0 scheduling gap of 1 may mean that a DCI on a PDCCH can schedule a PDSCH, at the soonest, in the next slot. A K1 scheduling gap may identify a minimum number of slots between receiving a PDSCH and transmitting a physical uplink control channel (PUCCH) with an acknowledgment (ACK) or negative ACK (HACK) for the PDSCH. A K1 scheduling gap of 0, for example, may mean that an ACK/NACK for a PDSCH can be transmitted in the same slot as the PDSCH, whereas a K1 scheduling gap of 1 may mean that an ACK/NACK for a PDSCH can be transmitted, at the soonest, in the next slot after the PDSCH is received. A K2 scheduling gap may identify a minimum number of slots between receiving a PDCCH DCI granting a resource for a physical uplink shared channel (PUSCH) and transmitting the PUSCH. A K2 scheduling gap of 0, for example, may mean that a DCI on a PDCCH can schedule a PUSCH in the same slot, whereas a K2 scheduling gap of 1 may mean that a DCI on a PDCCH can schedule a PUSCH, at the soonest, in the next slot. An a scheduling gap, also referred to as an aperiodic triggering offset, may identify a minimum number of slots between a PDCCH DCI and a channel state information reference signal (CSI-RS) triggered by the PDCCH DCI. An a scheduling gap of 0, for example, may mean that a DCI on a PDCCH can trigger a CSI-RS in the same slot, whereas an a scheduling gap of 1 may mean that a DCI on a PDCCH can trigger a CSI-RS, at the soonest, in the next slot. A b scheduling gap may identify a minimum number of slots associated with an aperiodic sounding reference signal (SRS) resource set, such as a minimum number of slots between receiving a PDCCH DCI triggering an SRS and transmitting the SRS. A b scheduling gap of 0, for example, may mean that a DCI on a PDCCH can trigger an SRS in the same slot, whereas a b scheduling gap of 1 may mean that a DCI on a PDCCH can trigger an SRS, at the soonest, in the next slot.

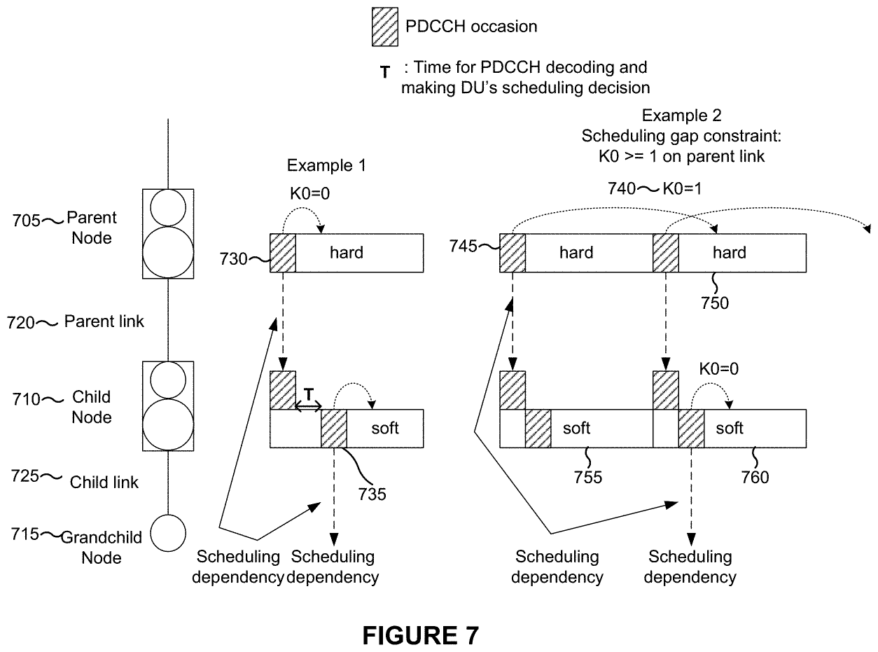

FIG. 7 shows implicit determination of availability of soft resources and conditional use of resources at an IAB node. FIG. 7 includes a parent node 705, a child node 710, and a grandchild node 715. FIG. 7 also shows a parent link 720 between the parent node 705 and the child node 710 and a child link 725 between the child node 710 and the grandchild node 715. The examples of FIG. 7 relate to implicit determination of available resources. For example, for implicit determination of availability of soft resources on the child link 725, the scheduling decision of the child node 710 may be based at least in part on the parent node 705's scheduling of resources on the parent link 720. If the child node 710 is associated with a time division multiplexing capability, the child node 710 cannot determine to use soft resources of the child node 710 on the child link 725 until after the child node 710 decodes a physical downlink control channel (PDCCH) of the parent node 705 and determines that the soft resources are not scheduled by the parent node 705. In the first example of FIG. 7 (Example 1), implicit determination of availability of a resource on the child link 725 is achieved by separating PDCCH resources 730 and 735 on the parent link 720 and the child link 725 by at least a time gap T to allow time for PDCCH decoding and scheduling. The approach shown in Example 1 involves considerable overhead when applied across all resources, since the time gap T may be greater than or equal to the time required to decode a PDCCH on the PDCCH resource 730 and schedule a PDCCH on the PDCCH resource 735. However, in Example 2, implicit determination of availability of a resource on the child link 725 is achieved by imposing a constraint on a scheduling gap 740 on the parent link 705. Here, the scheduling gap 740 is a K0 scheduling gap of 1, meaning that 1 slot must be provided between a PDCCH 745 and a corresponding PDSCH 750. As shown, a constraint of “K0>=1” is imposed on the parent link 720, meaning that the K0 scheduling gap of a PDCCH on the parent link must be greater than or equal to 1. This way, the child node 710 can perform scheduling in the slot 755 without having decoded the PDCCH 745, since the PDCCH 745 is enforced by the scheduling gap 740 to schedule communications in or after the slot 760. The approach shown in Example 2 may reduce overhead associated with decoding the PDCCH 745 and scheduling the PDCCH 750, but involves considerable latency when applied across all resources due to increasing the number of slots between a PDCCH and a corresponding PDSCH.

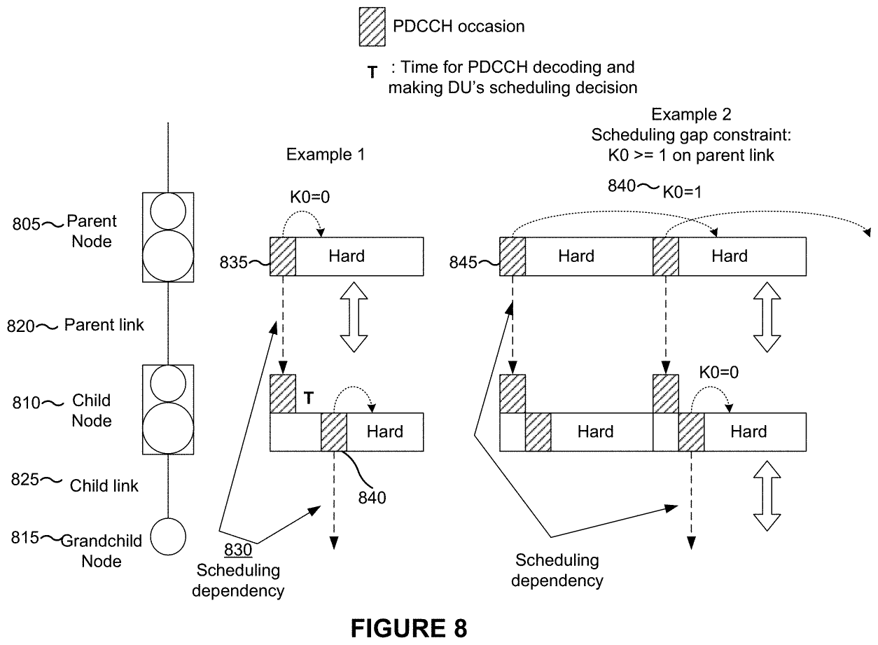

FIG. 8 shows conditional use of resources at an IAB node with an enhanced duplex capability. The examples shown in FIG. 8 involve a parent node 805, a child node 810, a grandchild node 815, a parent link 820, and a child link 825. For example, a child node 810 with an enhanced duplex capability can conditionally use resources (for example, based at least in part on beam directions). For example, resources of the parent link 820 and the child link 820 can both be configured as hard resources, since the child node 810 can simultaneously communicate on the parent link 820 and the child link 825. In such a case, only a subset of resources of the grandchild node 815 (for example, subject to restrictions on beam directions) may be scheduled if the subset of resources are used by the parent node 805 over the parent link 820. Thus, for improved use of resources, the child node 810's scheduling on the child link 825 may be based at least in part on scheduling dependencies 830 between resources 835 on the parent link 820 and resources 840 on the child link 825. In Example 1, a time gap T must be provided between the resources 820 and the resource 830. However, in Example 2, by imposing a minimum value of 1 for the K0 scheduling gap 840 on the parent link 820, the child node 810 is afforded sufficient time to determine the state of resources on the parent link 820, since the minimum value of 1 ensures that at least 1 slot is provided between a PDCCH 845 on the parent link 820 and a communication in a slot 850 on the parent link 820. For example, this additional time may ensure that the child node 810 has time to determine beam directions of communications on the parent link 820 during a slot 855 without having to take into account same-slot scheduling, thereby enabling conformance with restrictions on beam directions.

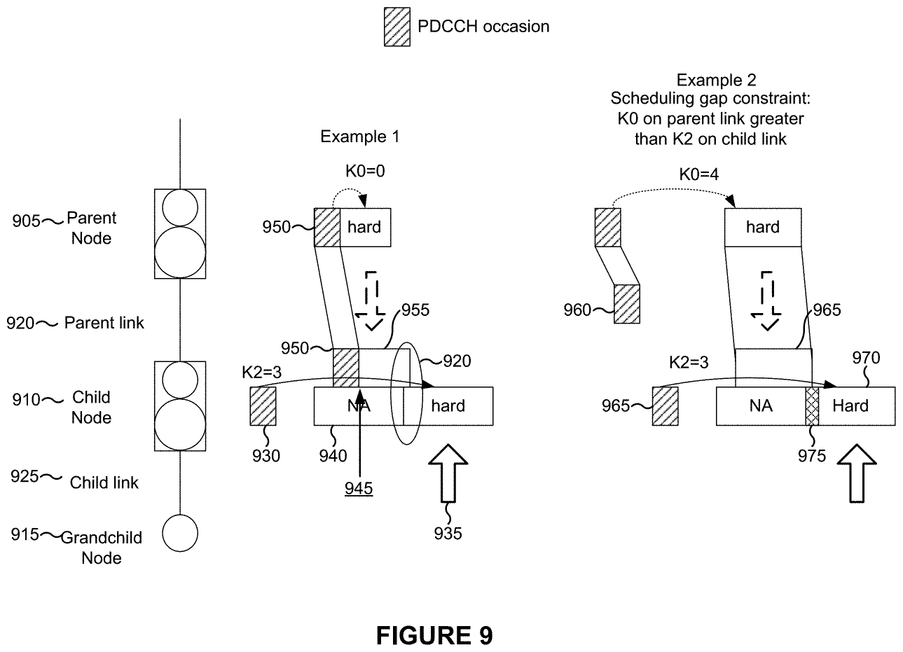

FIG. 9 shows an example of conditional use of resources in association with a transition from a downlink MT function to an uplink DU function of a child node 910. As shown, FIG. 9 involves a parent node 905, a child node 910, a grandchild node 915, a parent link 920, and a child link 925. In FIG. 9, the child node 910 is associated with a half-duplex constraint, such as a TDM configuration. The child node 910 may use an MT function for downlink communication on the parent link 920 and a DU function for uplink communication on the child link 925. As further shown, in Example 1, the parent link 920 is associated with a K0 scheduling gap of 0 and the child link 925 is associated with a K2 scheduling gap of 3, meaning that at least 3 symbols must be provided between a PDCCH 930 from the child node 910 and a PUSCH 935 from the grandchild node 915. Furthermore, the child node 910 is associated with a half-duplex constraint, so resources 940 on the child link 925 are configured as not available for the child node 910 since these resources are configured as hard on the parent link 920. Generally, a half-duplex-capable device may require some amount of time to transition between an MT function and a DU function, such as between a downlink MT function and an uplink DU function. FIG. 9 illustrates conditional use of resources so that sufficient time is provided for the transition without the transition interrupting data service of the nodes. A rightward shift in the resources of FIG. 9 indicates a propagation delay as a transmission moves from the parent node 905 to the child node 910.

Before a time 945, the child node 910 may not know whether dynamic scheduling has been performed by a parent node 905 using a PDCCH 950. In this case, as shown in Example 1, when the K2 scheduling gap of 3 slots is greater than the K0 scheduling gap of 0 slots, the child node 910 may need to leave a sufficient gap for a transition from an MT for reception of downlink communications on the parent link 920 to a DU of the child node 910 for communication with the grandchild node 915, irrespective of whether there is active communication at the parent link 920, in order to avoid a conflict between a communication 955 on the parent link 920 and the child link 925. The conflict is shown by reference number 920, where a resource on the parent link 920 overlaps a hard resource on the child link 925.

In contrast with Example 1, in Example 2, a minimum value for a K0 scheduling gap ensures that the K0 scheduling gap on the parent link 920 is longer than or equal to a K2 scheduling gap on the child link 925. In this example, the child node 910 can determine whether the parent node 905 has scheduled a communication on the parent link 920 because the PDCCH shown by reference number 960 precedes the PDCCH shown by reference number 965. The child node 910 can then determine whether additional gap symbols are needed for a transition from MT to DU based at least in part on the determination of whether the parent node 905 has scheduled a communication 965 on the parent link 920. For example, if the communication 965 overlaps a hard resource 970 on the child link 925, the child node 910 may configure one or more gap symbols 975 on the hard resource 970, so that the child node 910 can transition from the MT function on parent link 920 to the DU function on child link 925 without interrupting the communication 965 or a communication on the hard resource 970. A gap symbol may include an unused symbol, a symbol with a repetition of a communication, and/or the like. The child node 910 may configure a quantity and placement of gap symbols 975 such that the overlap between the communication 965 and the hard resource 970 is eliminated.

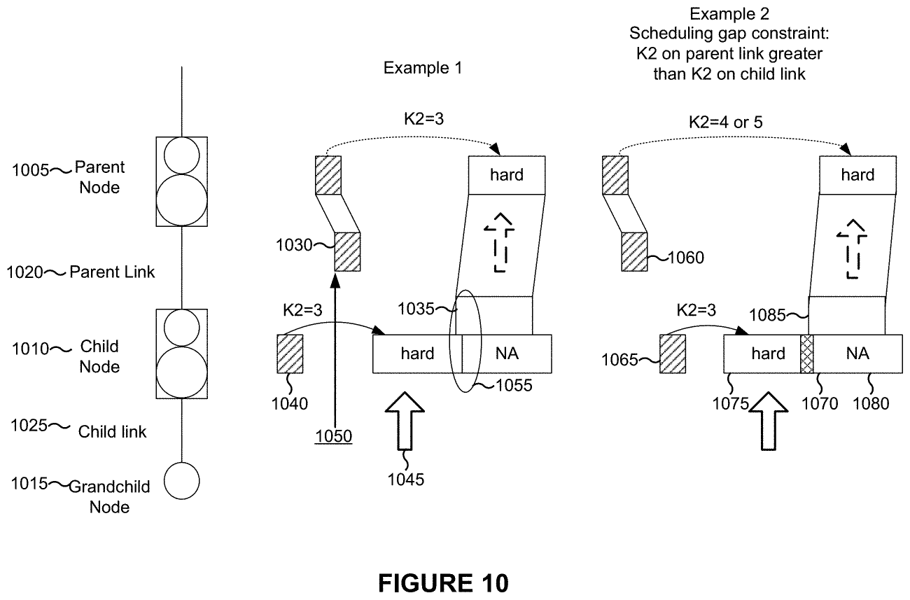

FIG. 10 shows conditional use of resources during a transition from an uplink DU function to an uplink MT function of a child node 1010. As shown, FIG. 10 involves a parent node 1005, a child node 1010, a grandchild node 1015, a parent link 1020, and a child link 1025. In Example 1 of FIG. 10, the parent link 1020 is associated with a K2 scheduling gap of 3 and the child link 1025 is associated with a K2 scheduling gap of 3. The K2 scheduling gap of 3 on the parent link 1020 may mean that 3 slots must be provided between a PDCCH 1030 from the parent node 1005 and a corresponding PUSCH 1035 from the child node 1010. The K2 scheduling gap of 3 on the child link 1025 may mean that 3 slots must be provided between a PDCCH 1040 from the child node 1010 and a corresponding PUSCH 1045 from the grandchild node 1015. The child node 1010 may use an uplink DU function when scheduling the PUSCH 1045 using the PDCCH 1040, and may use an uplink MT function to receive the PDCCH 1030 and transmit the PUSCH 1035.

Before a time 1050, the child node 1010 may not know whether the parent node 1005 has performed dynamic scheduling on the parent link 1020 (based at least in part on the PDCCH 1030). In that case, when the parent link 1020 and the child link 1025 are associated with the same K2 scheduling gap, the child node 1010 may need to leave a sufficient gap for a transition of the child node 1010 from an uplink DU function used to communicate with the grandchild node 1015 to the uplink MT function used to transmit the PUSCH 1035, irrespective of whether there is active communication on the parent link 1020, in order to avoid a potential resource conflict at the time 1055.

In Example 2, a minimum value for a K2 scheduling gap on the parent link 1020 is imposed such that the parent link 1020 must be associated with a longer K2 scheduling gap than the child link 1025. For example, the parent link 1020 is associated with a K2 scheduling gap of 4 or 5, and the child link 1025 is associated with a K2 scheduling gap of 3. In this example, by imposing a minimum value for the parent link 1020's K2 scheduling gap that is greater than the child link 1025's K2 scheduling gap, the child node 1010 can determine whether the parent node 1005 has performed scheduling on the parent link 1020, since the PDCCH 1060 is received at least one slot before the PDCCH 1065 is transmitted in conformance with the K2 scheduling gaps. The child node 1010 can thus decide whether additional gap symbols 1070 are needed for a transition of the child node 1010 from an uplink DU function in slot 1075 to an uplink MT function in slot 1080. For example, the child node 1010 may schedule one or more gap symbols 1070 on the slot 1075 so that transmission of a PUCCH 1085 by the MT function of the child node 1010 does not overlap operation of the DU function of the child node 1010 in the slot 1075. The child node 1010 may schedule the one or more gap symbols based at least in part on a number of actually overlapped symbols of the PUCCH 1085 and the slot 1075, a number of symbols needed for the transition of the child node 1010, or other factors.

In many of the examples described in connection with FIGS. 7, 8, 9, and 10, the child node 710 has a scheduling dependency relative to the parent node 705. In the Examples of FIGS. 7, 8, 9, and 10, imposing minimum values for scheduling gaps allows time for the child node 710 to determine the state of a resource associated with a scheduling dependency. However, if minimum values for scheduling gaps are applied indiscriminately, significant latency and overhead may result. For example, significant latency and overhead may occur if minimum values for scheduling gaps are applied across all resources on a link between IAB nodes, across repeating resources in every slot, or in all situations.

Various aspects relate generally to scheduling in an IAB network. Some aspects more specifically relate to imposing minimum values on scheduling gaps in connection with scheduling in an IAB network. In some aspects, the minimum values are applied to sets of resources or subsets of resources of a communication link of an IAB node. For example, a minimum value can be directly associated with a set of resources. As another example, a minimum value can be imposed on a set of resources based at least in part on a scenario (also referred to as a situation) associated with the set of resources, as described in more detail elsewhere herein. For example, a minimum value for a scheduling gap can be imposed based at least in part on a scenario, such as implicit determination of availability of soft resources (as described in connection with FIG. 7), scheduling of overlapped resources by a full duplex capability IAB node (as described in connection with FIG. 8), or a transition between an MT function and a DU function (as described in connection with FIGS. 9 and 10).

Particular aspects of the subject matter described in this disclosure can be implemented to realize one or more of the following potential advantages. In some examples, the described techniques can be used to improve efficiency of scheduling upstream and downstream IAB communications. Furthermore, the described techniques can be used to improve latency and overhead relative to scheduling without minimum values for scheduling gaps, and relative to indiscriminately applying scheduling gaps for all resources.

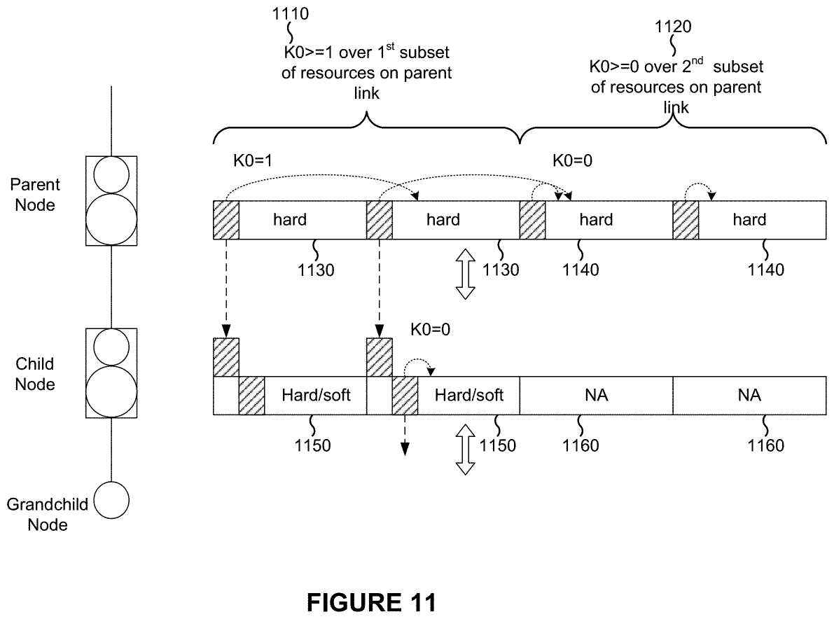

FIG. 11 shows a diagram illustrating an example of imposing a first minimum value 1110 for a scheduling gap on a first subset of resources and a second minimum value 1120 for the scheduling gap on a second subset of resources. The first subset of resources includes resources 1130 on a parent link between a parent node and a child node, and the second subset of resources includes resources 1140 on the parent link. The first subset of resources corresponds to resources 1150 on a child link between the child node and a grandchild node, and the second subset of resources corresponds to resources 1160 on the child link. The resources 1150 are available for the child node (e.g., are hard resources or soft resources) and the resources 1160 are not available for the child node.

As further shown, the child node may be associated with a grandchild node. The parent node, the child node, and the grandchild node may be IAB nodes of an IAB network. The parent node (or a CU associated with the parent node) may impose the first minimum value 1110 (which provides a minimum value for a K0 scheduling gap of 1 for the resources 1130 on a parent link between the parent node and the child node) on the first subset of resources based at least in part on resources 1150 of the child node being available for scheduling by the child node (for example, based at least in part on the resources 1150 in the first subset of resources being hard or soft). The parent node may impose the second minimum value 1120 (which provides a minimum K0 value of 0 for the resources 1140 on the parent link between the parent node and the child node) on the second subset of resources based at least in part on resources 1160 of the child node being unavailable (non-available or NA) for scheduling by the child node. For example, the parent node may impose the first minimum value 110 indicating a minimum value for a K0 scheduling gap of 1 on a parent link on resources 1130 of the child node that are available for scheduling by the child node, and may impose the second minimum value 1120 indicating a minimum value for a K0 scheduling gap of 0 for the resource 1140 based at least in part on the resources 1160 being unavailable

Thus, a sufficient scheduling gap can be provided in the first subset of resources for the child node to determine availability of such resources, and a less stringent scheduling gap can be used in the second subset of resources based at least in part on the different types of resources in the first subset of resources and the second subset of resources. For example, the resources 1150 of the child node may be dependent on a scheduling state of the resources 1130, and determining this scheduling state may take time. Thus, the first minimum value provides a minimum one-slot scheduling gap in which the child node can determine the scheduling state. However, since the resources 1160 are not available for scheduling by the child node, the child node needs not determine the scheduling state of the corresponding resources 1140. Therefore, imposing a minimum one-slot scheduling gap on the resources 1140 would increase latency without the benefit of providing the child node with time to determine the state of the resources 1140. By imposing different minimum values for scheduling gaps on the first subset of resources and the second subset of resources, allocation of resources is improved, and latency and overhead are reduced relative to uniformly applying a minimum value for the scheduling gap.

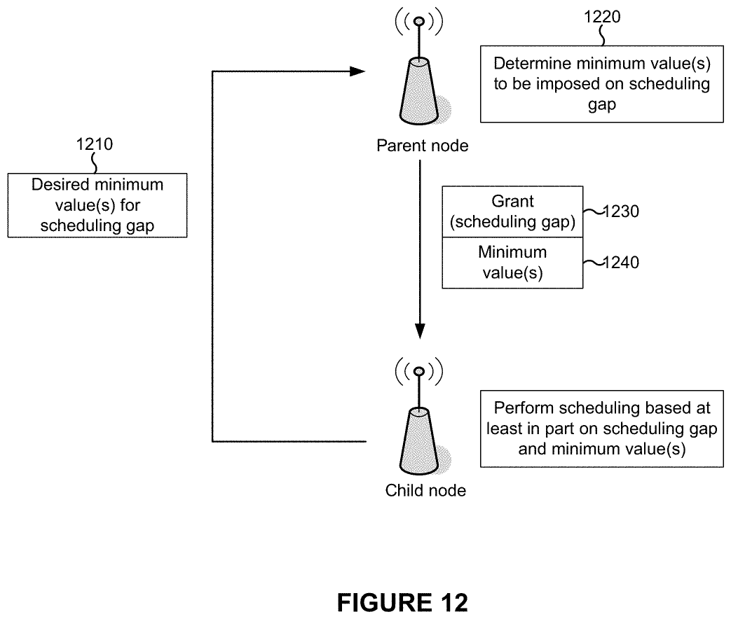

FIG. 12 shows a diagram illustrating an example of determination and imposition of a minimum value for a scheduling gap in accordance with various aspects of the present disclosure. As shown, FIG. 12 involves a parent node and a child node associated with the parent node. The parent node and the child node may be IAB nodes, such as IAB node 410. In some aspects, the child node may transmit, to the parent node, information 1210 indicating one or more preferred minimum values for a scheduling gap. The scheduling gap may include any one or more of the scheduling gaps described elsewhere herein, such as a K0 scheduling gap, a K1 scheduling gap, a K2 scheduling gap, an a scheduling gap, or a b scheduling gap. In some aspects, the information 1210 may indicate a set of resources to be associated with a preferred minimum value. In some aspects, the child node may transmit the information 1210 using medium access control (MAC) signaling such as a MAC control element (MAC-CE), an F1 application protocol (F1-AP) interface, radio resource control (RRC) signaling, or another form of signaling or interface.

As shown, the parent node may determine one or more minimum values 1220 for a scheduling gap. For example, the parent node may determine the one or more minimum values 1220 based at least in part on the information 1210, such as by selecting the one or more minimum values 1220 from one or more preferred minimum values indicated by the information 1210. In some aspects, the parent node may determine the one or more minimum values 1220 without reference to the information 1210. For example, in some aspects, the child node may not provide the information 1210 to the parent node. In some such examples, the parent node may determine the one or more minimum values based at least in part on information received from a CU of an IAB donor, as described in more detail elsewhere herein.

In some aspects, a minimum value may be associated with a set of resources. For example, a minimum value may be directly associated with a set of resources. In one example, a set of time-domain resources for which a minimum value is to be imposed can be specified, for example, using a bitmap or a vector indicating a starting resource and a length of the set of time-domain resources.

In some aspects, a minimum value may be associated with a set of resources corresponding to a specific resource type. A resource type of a resource may indicate whether the resource is a hard resource, a soft resource, or a resource type that is neither hard nor soft. A resource type of a resource may also indicate whether the resource is a downlink-only resource, an uplink-only resource, or a flexible resource. The resource type may relate to a resource of a given IAB node, a parent node of the given IAB node, or a child node of the given IAB node. For example, an IAB node may have knowledge of resource types of resources associated with a child node of the IAB node, and may have knowledge of a time division duplexing (TDD) pattern of a parent node of the IAB node (such as a pattern indicating downlink-only, uplink-only, and flexible resources of the parent node). In the above cases, as just a few examples, a minimum value may be imposed for flexible soft resources, for uplink-only hard resources, or for a subset of resources of a resource type.

In some aspects, a minimum value may be associated with a scenario in addition to a set of resources. For example, a minimum value may be imposed on a set of resources for the purpose of implicit determination of availability of soft resources, as described in connection with the second example of FIG. 7. In such a case, the child node or another parent node may perform implicit determination of availability of soft resources of the set of resources using the minimum value for the scheduling gap, and may perform other operations (for example, conditional use of resources at an IAB node with an enhanced duplex capability or conditional use of resources during an MT-DU transition) using a different minimum value or using no minimum value. As another example, a minimum value may be imposed on a set of resources for the purpose of conditional usage of resources on a parent link and a child link of a child node (such as for the purpose of a child node with enhanced duplex capabilities to schedule hard or soft resources on a child link that are overlapped with a parent node's hard or soft resources).

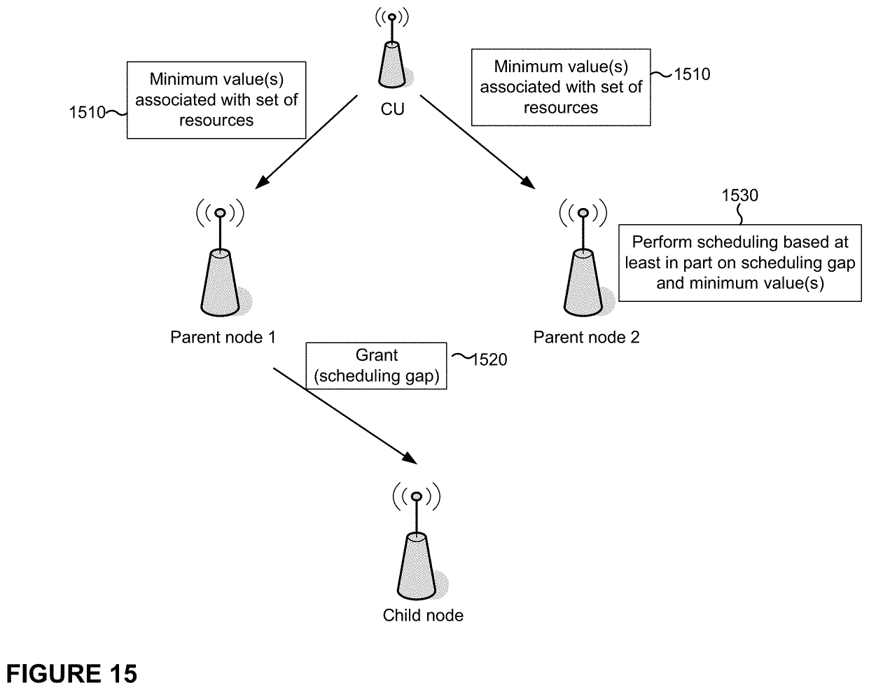

As yet another example, a minimum value may be imposed on a set of resources for the purpose of determination of resource availability during a transition between a DU function of a child node and an MT function of the child node. For example, if a parent node does not commit to providing one or more guard symbols for a transition (for example, an MT-to-DU or DU-to-MT transition of a child node, or an MT-MT transition of a parent node in a multi-IAB network such as in FIG. 15), then the parent node may determine a minimum value for a K0 or K2 scheduling gap to provide for scheduling on resources adjacent to the transition. Alternatively, if a parent node has committed to providing one or more guard symbols for a transition, then the parent node may not impose a minimum value on a scheduling gap associated with the transition. Thus, different minimum values can be imposed on a set of resources for different scenarios, thereby reducing latency and overhead relative to an inflexible approach for configuring minimum values, such as an approach in which the same minimum value is configured for all resources or for a given scheduling gap.

As shown, the parent node may transmit a grant 1230 to the child node. In some aspects, the grant 1230 may be associated with a scheduling gap, such as a K0 scheduling gap, a K1 scheduling gap, a K2 scheduling gap, an a scheduling gap, or a b scheduling gap. A scheduling gap may be configured using RRC signaling or carried in the grant, among other examples. As further shown, the parent node may transmit information 1240 indicating the one or more minimum values 1220 to the child node. In some aspects, the parent node may transmit the information 1240 using MAC signaling, such as a MAC-CE. In some aspects, the parent node may transmit the information 1240 in the grant 1230, such as in DCI carrying the grant 1230.

As shown, the child node may communicate based at least in part on the scheduling gap and the one or more minimum values. For example, the child node may perform scheduling of a communication (such as between the child node and a grandchild node or the child node and the parent node) on a set of resources in accordance with the scheduling gap and the one or more minimum values associated with the set of resources. In this way, the parent node can determine one or more minimum values corresponding to one or more sets of resources, and can signal the one or more minimum values to a child node. The child node can communicate in accordance with the one or more minimum values, such as by performing scheduling on the one or more sets of resources in accordance with the one or more minimum values. Thus, resource-specific selection and indication of minimum values for scheduling gaps is provided. By providing resource-specific (or resource-set-specific) selection and indication of minimum values, latency and overhead are reduced, relative to non-resource-specific selection and indication of minimum values, such as semi-static configuration of minimum values or configuration of minimum values across all resources.

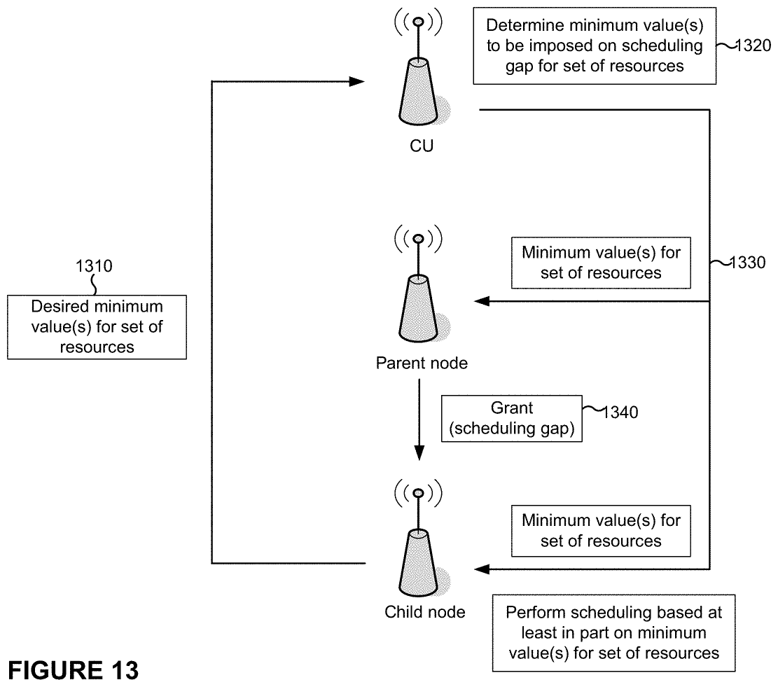

FIG. 13 shows an example of signaling and determination of a minimum value for a scheduling gap by a CU in accordance with various aspects of the present disclosure. As shown, the child node may transmit, to a CU (such as a CU associated with an IAB-donor 405), information 1310 indicating one or more preferred minimum values for the scheduling gap. For example, the information 1310 may include at least part of the information 1210 described in connection with FIG. 12.

As shown, the CU may determine one or more minimum values 1320 to be imposed on one or more scheduling gaps. For example, the CU may determine one or more minimum values 1320 for one or more sets of resources for communication by the parent node, the child node, or one or more other IAB nodes. In some aspects, the CU may determine the one or more minimum values 1320 based at least in part on resource types of the parent node or the child node, the information 1310 (such as by selecting the one or more minimum values 1320 from the one or more preferred minimum values), scheduling information for the parent node or the child node, or other information. As shown, the CU may transmit information 1330 indicating the one or more minimum values 1320 to at least one of the parent node or the child node. In some aspects, the CU may provide the information 1330 via an F1-AP interface or RRC signaling.

As shown, the parent node may transmit a grant 1340 to the child node. The grant may be associated with a scheduling gap, such as a scheduling gap associated with the one or more minimum values 1320 on a set of resources associated with the grant. As shown, the child node may communicate based at least in part on the minimum value and the scheduling gap. For example, the child node may perform scheduling on the set of resources based at least in part on the scheduling gap and the one or more minimum values 1320.

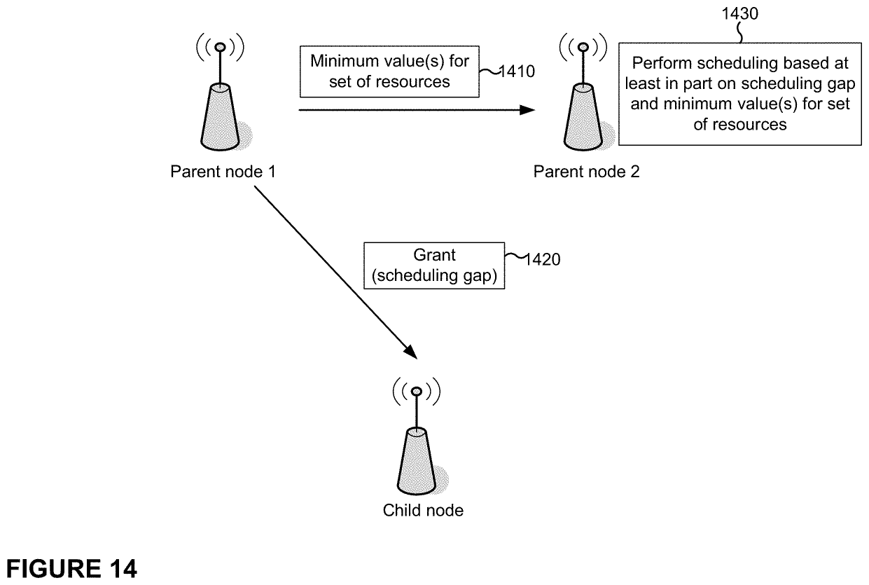

FIGS. 14 and 15 are diagrams illustrating examples of imposition of a minimum value for a scheduling gap on a set of resources in a multi-parent IAB network in accordance with various aspects of the present disclosure. As shown, the examples illustrated in FIGS. 14 and 15 involve a first parent node (Parent node 1) and a second parent node (Parent node 2). The first parent node and the second parent node may both be parent nodes of a child node as shown in FIGS. 14 and 15. However, the techniques and apparatuses described with regard to FIGS. 14 and 15 can be applied for parent nodes that are not associated with a same child node.

As shown in FIG. 14, the first parent node may provide, to the second parent node, information 1410 indicating one or more minimum values of a scheduling gap for a set of resources. For example, the information 1410 may include at least part of the information 1210 or the information 1310. The first parent node may determine the information 1410 as described elsewhere herein. In some aspects, the first parent node may provide a grant 1420 to the child node. For example, the grant 1420 may schedule a communication, such as on a set of resources a parent link or a child link of the child node. The set of resources on which the grant 1420 schedules the communication may be associated with a scheduling gap that is subject to one or more minimum values for the scheduling gap. For example, the scheduling gap may directly apply to the set of resources on which the grant 1420 schedules the communication, or may apply to a set of resources on which the set of resources scheduled by the grant 1420 have a dependency. As shown by reference number 1430, the second parent node may perform scheduling based at least in part on the one or more minimum values for the set of resources. For example, the second parent node may schedule communications with the child node or by the child node on the set of resources in accordance with the one or more minimum values.

FIG. 15 shows an example including a CU, such as a CU associated with an IAB-donor 405. As shown in FIG. 15, the CU may provide information 1510 indicating a set of minimum values associated with a set of resources. For example, the CU may provide the information 1510 to at least one of a first parent node (Parent node 1) or a second parent node (Parent node 2). The CU may determine the information 1510 as described elsewhere herein. In some aspects, the CU may provide the information 1510 via an F1-AP interface, RRC signaling, or another form of signaling. In some aspects, the first parent node may provide a grant 1520 to a child node. For example, the grant 1520 may schedule a communication, such as on a set of resources a parent link or a child link of the child node. The set of resources on which the grant 1520 schedules the communication may be associated with a scheduling gap that is subject to one or more minimum values for the scheduling gap. For example, the scheduling gap may directly apply to the set of resources on which the grant 1520 schedules the communication, or may apply to a set of resources on which the set of resources scheduled by the grant 1520 have a dependency. As shown by reference number 1530, the second parent node may communicate in accordance with the one or more minimum values. For example, the second parent node may schedule communications on or associated with the set of resources in accordance with the one or more minimum values. Thus, different minimum values can be imposed on a set of resources for different scenarios, thereby reducing latency and overhead, relative to an inflexible approach for configuring minimum values, such as an approach in which the same minimum value is configured for all resources or for a given scheduling gap.

FIG. 16 is a flowchart illustrating an example process 1600 performed, for example, by a first node in accordance with various aspects of the present disclosure. Example process 1600 is an example where the first node (for example, the IAB-node 410, the IAB node shown in FIG. 6, the child node of FIG. 11, the parent node of FIGS. 12 and 13, the first parent node of FIGS. 14 and 15, among other examples) performs operations associated with configuring a threshold scheduling gap for an IAB network.

As shown in FIG. 16, in some aspects, process 1600 may include transmitting a grant for a communication associated with a scheduling gap, wherein the scheduling gap is imposed with a threshold value over a set of resources (block 1610). For example, the first node (such as using controller/processor 240, transmit processor 220, TX MIMO processor 230, MOD 232, antenna 234, a DU function of the first node, or an MT function of the first node) may transmit a grant for a communication associated with a scheduling gap, as described above. In some aspects, the scheduling gap is imposed with a threshold value over a set of resources.

As further shown in FIG. 16, in some aspects, process 1600 may include communicating with a second node based at least in part on the grant (block 1620). For example, the first node (such as using controller/processor 240, transmit processor 220, TX MIMO processor 230, MOD 232, antenna 234, a DU function of the first node, or an MT function of the first node) may communicate with a second node based at least in part on the grant, as described above. In some aspects, the first node may transmit a communication to or receive a communication from the second node in accordance with the grant. In some aspects, the first node may perform a communication with the second node based at least in part on a multi-parent IAB network configuration.

Process 1600 may include additional aspects, such as any single aspect or any combination of aspects described below or in connection with one or more other processes described elsewhere herein.

In a first aspect, the threshold value is indicated to the second node.

In a second additional aspect, process 1600 includes receiving, from the second node, information indicating one or more preferred threshold values, wherein the threshold value is based at least in part on the information indicating the one or more preferred threshold values.

In a third additional aspect, alone or in combination with one or more of the first and second aspects, process 1600 includes receiving, from the second node, information indicating one or more preferred threshold values, wherein the threshold value is based at least in part on the information indicating the one or more preferred threshold values.

In a fourth additional aspect, alone or in combination with one or more of the first through third aspects, process 1600 includes receiving the information indicating the one or more preferred threshold values via medium access control signaling.

In a fifth additional aspect, alone or in combination with one or more of the first through fourth aspects, information indicating the threshold value is transmitted in the grant.

In a sixth additional aspect, alone or in combination with one or more of the first through fifth aspects, information indicating the threshold value is transmitted via medium access control signaling.

In a seventh additional aspect, alone or in combination with one or more of the first through sixth aspects, the threshold value is based at least in part on the first node and the second node being associated with an integrated access and backhaul (IAB) network.

In an eighth additional aspect, alone or in combination with one or more of the first through seventh aspects, the first node is a parent node and the second node is a child node of the parent node.

In a ninth additional aspect, alone or in combination with one or more of the first through eighth aspects, the first node is a first parent node and the second node is a second parent node, and the IAB network is a multi-parent IAB network.

In a tenth additional aspect, alone or in combination with one or more of the first through ninth aspects, the scheduling gap comprises at least one of: a physical downlink shared channel scheduling gap, a physical downlink control channel scheduling gap, a physical uplink control channel scheduling gap, a scheduling gap associated with triggering a channel state information reference signal, or a scheduling gap associated with a sounding reference signal.

In an eleventh additional aspect, alone or in combination with one or more of the first through tenth aspects, the set of resources is a set of time resources. The process 1600 may include receiving or determining information indicating that the threshold value is associated with the set of resources, wherein the information includes at least one of a bitmap or information indicating a start of the set of resources and a length of the set of resources.

In a twelfth additional aspect, alone or in combination with one or more of the first through eleventh aspects, the set of resources is associated with a resource type for at least one of: the first node, a parent node of the first node, or a child node of the first node.

In a thirteenth additional aspect, alone or in combination with one or more of the first through twelfth aspects, the resource type comprises at least one of: a hard resource type, a soft resource type, a resource type that is neither hard nor soft, a downlink-only resource type, an uplink-only resource type, or a flexible resource type.

In a fourteenth additional aspect, alone or in combination with one or more of the first through thirteenth aspects, process 1600 includes receiving, from a central unit, information indicating the threshold value

In a fifteenth additional aspect, alone or in combination with one or more of the first through fourteenth aspects, the information indicating the threshold value is received via an F1 application protocol interface.

In a sixteenth additional aspect, alone or in combination with one or more of the first through fifteenth aspects, the information indicating the threshold value is received via radio resource control signaling from a mobile termination function of a parent node of the first node.

In a seventeenth additional aspect, alone or in combination with one or more of the first through sixteenth aspects, the information indicating the threshold value is based at least in part on information indicating one or more preferred threshold values provided to the central unit by the second node.

In an eighteenth additional aspect, alone or in combination with one or more of the first through seventeenth aspects, the information indicating the one or more preferred threshold values is provided from the second node to the central unit via at least one of: an F1 application protocol interface, or radio resource control signaling.

In a nineteenth additional aspect, alone or in combination with one or more of the first through eighteenth aspects, the threshold value is one of a plurality of threshold values associated with respective scenarios.

In a twentieth additional aspect, alone or in combination with one or more of the first through nineteenth aspects, the threshold value is associated with a scenario associated with implicit determination of availability of a soft resource of the second node.

In a twenty-first additional aspect, alone or in combination with one or more of the first through twentieth aspects, the threshold value is associated with a scenario associated with conditional usage of resources on a parent link and a child link of the second node.

In a twenty-second additional aspect, alone or in combination with one or more of the first through twenty-first aspects, the threshold value is associated with a scenario associated with determination of resource availability during a transition between a distributed unit function of the second node and a mobile termination function of the second node.

In a twenty-third additional aspect, alone or in combination with one or more of the first through twenty-second aspects, the threshold value is based at least in part on whether the first node has configured one or more guard symbols for the transition.

In a twenty-fourth additional aspect, alone or in combination with one or more of the first through twenty-third aspects, the threshold value comprises a minimum value for the scheduling gap.

Although FIG. 16 shows example blocks of process 1600, in some aspects, process 1600 may include additional blocks, fewer blocks, different blocks, or differently arranged blocks than those depicted in FIG. 16. Additionally or alternatively, two or more of the blocks of process 1600 may be performed in parallel.

FIG. 17 is a flowchart illustrating an example process 1700 performed, for example, by a first node in accordance with various aspects of the present disclosure. Example process 1700 is an example where the first node (for example, the IAB-node 410, the child node shown in FIG. 6, the grandchild node of FIG. 11, the child node of FIGS. 12, 13, 14, and 15, among other examples) performs operations associated with configuring a threshold value for a scheduling gap for an IAB network.

As shown in FIG. 17, in some aspects, process 1700 may include receiving information indicating a scheduling gap associated with a second node, wherein the scheduling gap is imposed with a threshold value over a set of resources (block 1710). For example, the first node (such as using antenna 234, DEMOD 232, MIMO detector 236, receive processor 238, controller/processor 240, a DU function of the first node, an MT function of the first node, among other examples) may receive information indicating a scheduling gap associated with a second node, as described above. In some aspects, the scheduling gap is imposed with a threshold value over a set of resources.

As further shown in FIG. 17, in some aspects, process 1700 may include communicating based at least in part on the scheduling gap (block 1720). For example, the first node ((such as using antenna 234, DEMOD 232, MIMO detector 236, receive processor 238, controller/processor 240, a DU function of the first node, an MT function of the first node, among other examples) may communicate based at least in part on the scheduling gap, as described above. In some cases, the first node may communicate in accordance with a grant provided by the second node. In some cases, the first node may schedule communications based at least in part on the scheduling gap (and the threshold value associated with the set of resources).

Process 1700 may include additional aspects, such as any single aspect or any combination of aspects described below or in connection with one or more other processes described elsewhere herein.

In a first aspect, process 1700 includes receiving information indicating the threshold value from the second node.

In a second additional aspect, alone or in combination with the first aspect, process 1700 includes transmitting, to the second node, information indicating one or more preferred threshold values, wherein the threshold value is based at least in part on the information indicating the one or more preferred threshold values.

In a third additional aspect, alone or in combination with one or more of the first and second aspects, process 1700 includes transmitting the information indicating the one or more preferred threshold values via medium access control signaling.

In a fourth additional aspect, alone or in combination with one or more of the first through third aspects, information indicating the threshold value is received in a grant for communication by the first node.

In a fifth additional aspect, alone or in combination with one or more of the first through fourth aspects, information indicating the threshold value is received via medium access control signaling.

In a sixth additional aspect, alone or in combination with one or more of the first through fifth aspects, the threshold value is based at least in part on the first node and the second node being associated with an integrated access and backhaul (IAB) network.

In a seventh additional aspect, alone or in combination with one or more of the first through sixth aspects, the second node is a parent node and the first node is a child node of the parent node.

In an eighth additional aspect, alone or in combination with one or more of the first through seventh aspects, the first node is a first parent node and the second node is a second parent node, and the IAB network is a multi-parent IAB network.

In a ninth additional aspect, alone or in combination with one or more of the first through eighth aspects, the scheduling gap comprises at least one of: a physical downlink shared channel scheduling gap, a physical downlink control channel scheduling gap, a physical uplink control channel scheduling gap, a scheduling gap associated with triggering a channel state information reference signal, or a scheduling gap associated with a sounding reference signal.

In a tenth additional aspect, alone or in combination with one or more of the first through ninth aspects, the set of resources is a set of time resources, process 1700 includes receiving information indicating that the threshold value is associated with the set of resources, and the information comprises at least one of a bitmap or information indicating a start of the set of resources and a length of the set of resources.

In an eleventh additional aspect, alone or in combination with one or more of the first through tenth aspects, the set of resources is associated with a resource type for at least one of: the first node, a parent node of the first node, or a child node of the first node.

In a twelfth additional aspect, alone or in combination with one or more of the first through eleventh aspects, the resource type comprises at least one of: a hard resource type, a soft resource type, a resource type that is neither hard nor soft, a downlink-only resource type, an uplink-only resource type, or a flexible resource type.

In a thirteenth additional aspect, alone or in combination with one or more of the first through twelfth aspects, the threshold value is based at least in part on the information indicating the one or more preferred threshold values.

In a fourteenth additional aspect, alone or in combination with one or more of the first through thirteenth aspects, the information indicating the one or more preferred threshold values is transmitted to the second node via medium access control signaling.

In a fifteenth additional aspect, alone or in combination with one or more of the first through fourteenth aspects, the information indicating the one or more preferred threshold values is transmitted to the central unit via at least one of: an F1 application protocol interface, or radio resource control signaling.

In a sixteenth additional aspect, alone or in combination with one or more of the first through fifteenth aspects, the threshold value is one of a plurality of threshold values associated with respective scenarios.

In a seventeenth additional aspect, alone or in combination with one or more of the first through sixteenth aspects, the threshold value is associated with a scenario associated with implicit determination of availability of a soft resource of the first node.

In an eighteenth additional aspect, alone or in combination with one or more of the first through seventeenth aspects, the threshold value is associated with a scenario associated with conditional usage of resources on a parent link and a child link of the first node.

In a nineteenth additional aspect, alone or in combination with one or more of the first through eighteenth aspects, the threshold value is associated with a scenario associated with determination of resource availability during a transition between a distributed unit function of the second node and a mobile termination function of the first node.

In a twentieth additional aspect, alone or in combination with one or more of the first through nineteenth aspects, the threshold value is based at least in part on whether the second node has configured one or more guard symbols for the transition.

In a twenty-first additional aspect, alone or in combination with one or more of the first through twentieth aspects, process 1700 includes an F1 application protocol interface, or radio resource control signaling.

In a twenty-second additional aspect, alone or in combination with one or more of the first through twenty-first aspects, the threshold value comprises a minimum value for the scheduling gap.

Although FIG. 17 shows example blocks of process 1700, in some aspects, process 1700 may include additional blocks, fewer blocks, different blocks, or differently arranged blocks than those depicted in FIG. 17. Additionally or alternatively, two or more of the blocks of process 1700 may be performed in parallel.

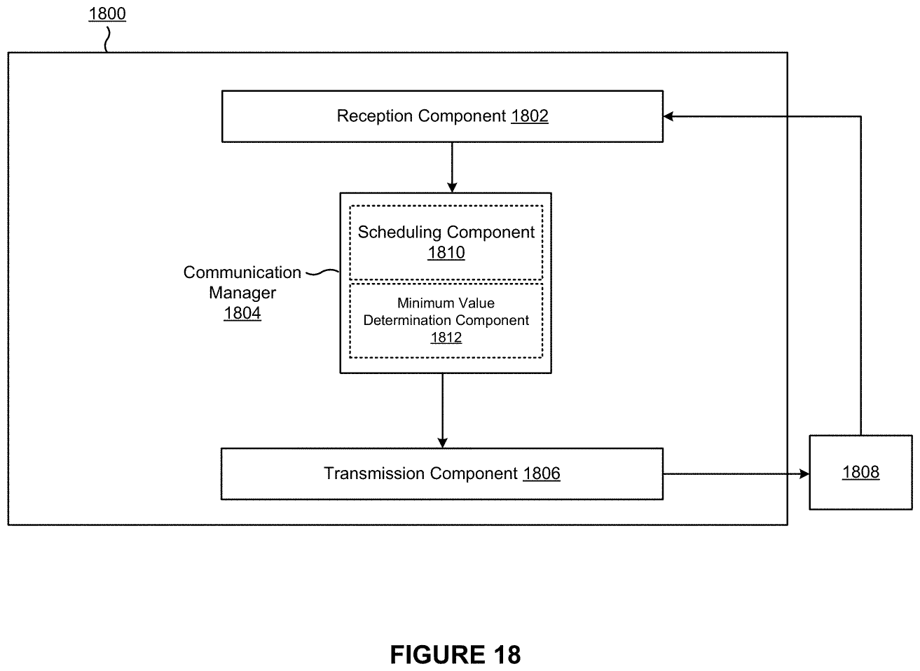

FIG. 18 is a block diagram of an example apparatus 1800 for wireless communication in accordance with various aspects of the present disclosure. The apparatus 1800 may be a first node, or a first node may include the apparatus 1800. In some aspects, the apparatus 1800 includes a reception component 1802, a communication manager 1804, and a transmission component 1806, which may be in communication with one another (for example, via one or more buses). As shown, the apparatus 1800 may communicate with another apparatus 1808 (such as a UE, a base station, or another wireless communication device) using the reception component 1802 and the transmission component 1806.

In some aspects, the apparatus 1800 may be configured to perform one or more operations described herein in connection with FIGS. 6 through 15. Additionally or alternatively, the apparatus 1800 may be configured to perform one or more processes described herein, such as process 1600 of FIG. 16. In some aspects, the apparatus 1800 may include one or more components of the first node described above in connection with FIG. 2.

The reception component 1802 may receive communications, such as reference signals, control information, data communications, or a combination thereof, from the apparatus 1808. The reception component 1802 may provide received communications to one or more other components of the apparatus 1800, such as the communication manager 1804. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1802 may include one or more antennas, a demodulator, a MIMO detector, a receive processor, a controller/processor, a memory, or a combination thereof, of the first node described above in connection with FIG. 2.

The transmission component 1806 may transmit communications, such as reference signals, control information, data communications, or a combination thereof, to the apparatus 1808. In some aspects, the communication manager 1804 may generate communications and may transmit the generated communications to the transmission component 1806 for transmission to the apparatus 1808. In some aspects, the transmission component 1806 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1806 may include one or more antennas, a modulator, a transmit MIMO processor, a transmit processor, a controller/processor, a memory, or a combination thereof, of the first node described above in connection with FIG. 2. In some aspects, the transmission component 1806 may be collocated with the reception component 1802 in a transceiver.

The communication manager 1804 may transmit a grant for a communication associated with a scheduling gap, wherein the scheduling gap is imposed with a threshold value over a set of resources, and communicate with a second node based at least in part on the grant. In some aspects, the communication manager 1804 may include a controller/processor, a memory, a scheduler, a communication unit, or a combination thereof, of the first node described above in connection with FIG. 2.

In some aspects, the communication manager 1804 may include a set of components, such as a scheduling component 1810, a threshold value determination component 1812, or a combination thereof. Alternatively, the set of components may be separate and distinct from the communication manager 1804. In some aspects, one or more components of the set of components may include or may be implemented within a controller/processor, a memory, a scheduler, a communication unit, or a combination thereof, of the first node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1806 may transmit a grant for a communication associated with a scheduling gap, wherein the scheduling gap is imposed with a threshold value over a set of resources. In some aspects, the transmission component 1806 may transmit, to a second node, information indicating the threshold value.

The reception component 1802 may receive, from the second node, information indicating one or more preferred threshold values, wherein the threshold value is based at least in part on the information indicating the one or more preferred threshold values (such as via medium access control signaling). In some aspects, the reception component 1802 may receive information indicating that the threshold value is associated with the set of resources, wherein the information includes at least one of a bitmap or information indicating a start of the set of resources and a length of the set of resources. In some aspects, the reception component 1802 may receive, from a central unit, information indicating the threshold value

The scheduling component 1810 may determine the grant. In some aspects, the scheduling component 1810 may schedule communications with or by the second node. For example, the scheduling component 1810 may transmit the grant for the communication associated with the scheduling gap. In some aspects, the scheduling component 1810 may schedule such communications in accordance with the threshold value. The threshold value determination component 1812 may determine the threshold value based at least in part on the information indicating the one or more preferred threshold values. In some aspects, the threshold value determination component 1812 may determine information indicating that the threshold value is associated with the set of resources, wherein the information includes at least one of a bitmap or information indicating a start of the set of resources and a length of the set of resources

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally or alternatively, a set of (one or more) components shown in FIG. 18 may perform one or more functions described as being performed by another set of components shown in FIG. 18.

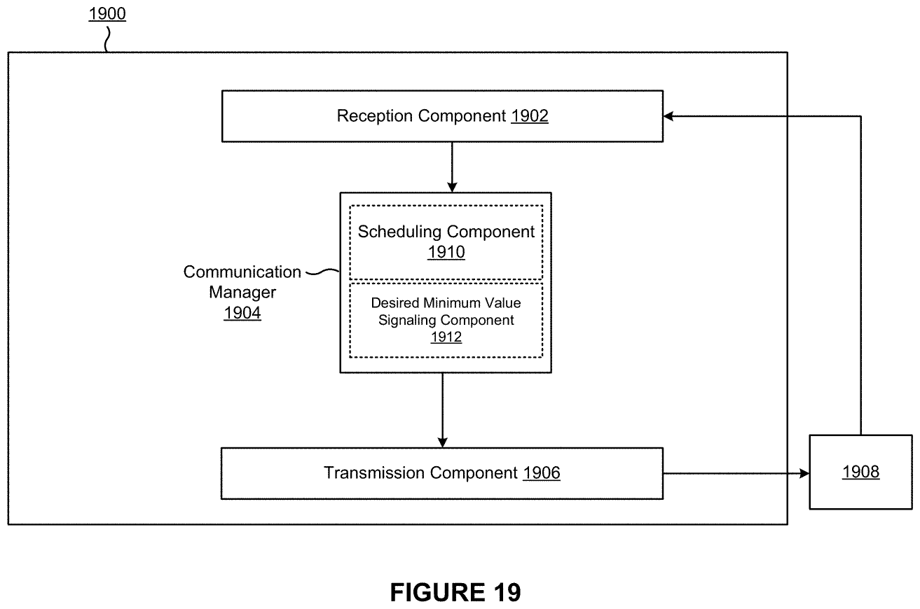

FIG. 19 is a block diagram of an example apparatus 1900 for wireless communication in accordance with various aspects of the present disclosure. The apparatus 1900 may be a first node, or a first node may include the apparatus 1900. In some aspects, the apparatus 1900 includes a reception component 1902, a communication manager 1904, and a transmission component 1906, which may be in communication with one another (for example, via one or more buses). As shown, the apparatus 1900 may communicate with another apparatus 1908 (such as a UE, a base station, or another wireless communication device) using the reception component 1902 and the transmission component 1906.

In some aspects, the apparatus 1900 may be configured to perform one or more operations described herein in connection with FIGS. 6 through 15. Additionally or alternatively, the apparatus 1900 may be configured to perform one or more processes described herein, such as process 1700 of FIG. 17. In some aspects, the apparatus 1900 may include one or more components of the first node described above in connection with FIG. 2.

The reception component 1902 may receive communications, such as reference signals, control information, data communications, or a combination thereof, from the apparatus 1908. The reception component 1902 may provide received communications to one or more other components of the apparatus 1900, such as the communication manager 1904. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1902 may include one or more antennas, a demodulator, a MIMO detector, a receive processor, a controller/processor, a memory, or a combination thereof, of the first node described above in connection with FIG. 2.

The transmission component 1906 may transmit communications, such as reference signals, control information, data communications, or a combination thereof, to the apparatus 1908. In some aspects, the communication manager 1904 may generate communications and may transmit the generated communications to the transmission component 1906 for transmission to the apparatus 1908. In some aspects, the transmission component 1906 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1906 may include one or more antennas, a modulator, a transmit MIMO processor, a transmit processor, a controller/processor, a memory, or a combination thereof, of the first node described above in connection with FIG. 2. In some aspects, the transmission component 1906 may be collocated with the reception component 1902 in a transceiver.

The communication manager 1904 may receive information indicating a scheduling gap associated with a second node, wherein the scheduling gap is imposed with a threshold value over a set of resources; and communicate based at least in part on the threshold value. In some aspects, the communication manager 1904 may include a controller/processor, a memory, a scheduler, a communication unit, or a combination thereof, of the first node described above in connection with FIG. 2.

In some aspects, the communication manager 1904 may include a set of components, such as a scheduling component 1910, a preferred threshold value signaling component 1912, or a combination thereof. Alternatively, the set of components may be separate and distinct from the communication manager 1904. In some aspects, one or more components of the set of components may include or may be implemented within a controller/processor, a memory, a scheduler, a communication unit, or a combination thereof, of the first node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The scheduling component 1910 may schedule communications in accordance with the threshold value (for example, if the apparatus 1900 is a parent node). The preferred threshold value signaling component 1912 may transmit, to the second node, information indicating one or more preferred threshold values, wherein the threshold value is based at least in part on the information indicating the one or more preferred threshold values (such as via MAC signaling). In some aspects, the preferred threshold value signaling component 1912 may transmit, to a central unit, information indicating one or more preferred threshold values, wherein the threshold value is based at least in part on the information indicating the one or more preferred threshold values

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally or alternatively, a set of (one or more) components shown in FIG. 19 may perform one or more functions described as being performed by another set of components shown in FIG. 19.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or combinations thereof.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A method of wireless communication performed by a first node in an integrated access and backhaul (IAB) network, comprising:
receiving information indicating a threshold value associated with a scheduling gap;
transmitting a grant for a communication associated with the scheduling gap, wherein the scheduling gap is imposed with the threshold value over a set of resources; and
communicating with a second node based at least in part on the grant.

2. The method of claim 1, wherein the threshold value comprises a minimum value for the scheduling gap.

3. The method of claim 1, further comprising:
transmitting, to the second node, the information indicating the threshold value.

4. The method of claim 3, wherein the information indicating the threshold value is transmitted in the grant.

5. The method of claim 3, wherein the information indicating the threshold value is transmitted via medium access control signaling.

6. The method of claim 1, further comprising receiving, from the second node via medium access control signaling, information indicating one or more preferred threshold values, wherein the threshold value is based at least in part on the information indicating the one or more preferred threshold values.

7. The method of claim 1, wherein the first node is a parent node and the second node is a child node of the parent node.

8. The method of claim 1, wherein the first node is a first parent node and the second node is a second parent node, and wherein the IAB network is a multi-parent IAB network.

9. The method of claim 1, wherein the scheduling gap comprises at least one of:
a physical downlink shared channel scheduling gap,
a physical downlink control channel scheduling gap,
a physical uplink control channel scheduling gap,
a scheduling gap associated with triggering a channel state information reference signal, or
a scheduling gap associated with a sounding reference signal.

10. The method of claim 1, wherein the set of resources is a set of time resources, wherein the method further comprises receiving or determining information indicating that the threshold value is associated with the set of resources, and wherein the information indicating that the threshold value is associated with the set of resources includes at least one of a bitmap or information indicating a start of the set of resources and a length of the set of resources.

11. The method of claim 1, wherein the set of resources is associated with a resource type for at least one of:
the first node,
a parent node of the first node, or
a child node of the first node.

12. The method of claim 11, wherein the resource type comprises at least one of:
a hard resource type,
a soft resource type,
a resource type that is neither hard nor soft,
a downlink-only resource type,
an uplink-only resource type, or
a flexible resource type.

13. The method of claim 1, wherein receiving the information indicating the threshold value comprises:
receiving, from a central unit, the information indicating the threshold value.

14. The method of claim 13, wherein the information indicating the threshold value is received via an F1 application protocol interface or via radio resource control signaling from a mobile termination function of a parent node of the first node.

15. The method of claim 13, wherein the information indicating the threshold value is based at least in part on information indicating one or more preferred threshold values provided to the central unit by the second node via at least one of:
an F1 application protocol interface, or
radio resource control signaling.

16. The method of claim 1, wherein the threshold value is one of a plurality of threshold values associated with respective scenarios.

17. The method of claim 1, wherein the threshold value is associated with a scenario associated with implicit determination of availability of a soft resource of the second node.

18. The method of claim 1, wherein the threshold value is associated with a scenario associated with conditional usage of resources on a parent link and a child link of the second node.

19. The method of claim 1, wherein the threshold value is associated with a scenario associated with determination of resource availability during a transition between a distributed unit function of the second node and a mobile termination function of the second node.

20. The method of claim 19, wherein the threshold value is based at least in part on whether the first node has configured one or more guard symbols for the transition.

21. A method of wireless communication performed by a first node in an integrated access and backhaul (IAB) network, comprising:
transmitting information indicating a threshold value associated with a scheduling gap;
receiving information indicating the scheduling gap associated with a second node,
wherein the scheduling gap is imposed with the threshold value over a set of resources; and
communicating based at least in part on the threshold value.

22. The method of claim 21, wherein the threshold value comprises a minimum value for the scheduling gap.

23. The method of claim 21, wherein receiving the information indicating the threshold value comprises:
receiving the information indicating the threshold value from the second node.

24. The method of claim 23, further comprising transmitting, to the second node, information indicating one or more preferred threshold values, wherein the threshold value is based at least in part on the information indicating the one or more preferred threshold values.

25-30. (canceled)

31. The method of claim 21, wherein the set of resources is associated with a resource type for at least one of:
the first node,
a parent node of the first node, or
a child node of the first node.

32. (canceled)

33. The method of claim 21, further comprising transmitting, to the second node or a central unit, information indicating one or more preferred threshold values, wherein the threshold value is based at least in part on the information indicating the one or more preferred threshold values.

34-41. (canceled)

42. A first node of an integrated access and backhaul (TAB) network for wireless communication, comprising:
a memory; and
one or more processors coupled to the memory, the memory and the one or more processors configured to:
receive information indicating a threshold value associated with a scheduling gap;
transmit a grant for a communication associated with the scheduling gap,
wherein the scheduling gap is imposed with the threshold value over a set of resources; and
communicate with a second node based at least in part on the grant.

43. The first node of claim 42, wherein the threshold value comprises a minimum value for the scheduling gap.

44-49. (canceled)

50. A first node for wireless communication, comprising:
a memory; and
one or more processors coupled to the memory, the memory and the one or more processors configured to:
transmit information indicating a threshold value associated with a scheduling gap;
receive information indicating the scheduling gap associated with a second node,
wherein the scheduling gap is imposed with a minimum value over a set of resources; and
communicate based at least in part on the scheduling gap.

51. The first node of claim 50, wherein the threshold value comprises a minimum value for the scheduling gap.

52-56. (canceled)
